(19) United States
(12) Patent Application Publication
(10) Pub. No.: US 2026/0288338 A1
(43) Pub. Date: Sep. 24, 2026

(54) SEMICONDUCTOR MEMORY DEVICE AND CONTROLLER

(71) Applicant: Kioxia Corporation, Tokyo (JP)

(72) Inventors: Akihiro FUKUSHIMA, Yokohama (JP); Tamio SAIMEN, Yokohama (JP)

(73) Assignee: Kioxia Corporation, Tokyo (JP)

(21) Appl. No.: 19/262,234

(22) Filed: Jul. 8, 2025

(30) Foreign Application Priority Data
Mar. 19, 2025 (JP) 2025-045627

(51) Int. Cl. G06F 3/06

(52) U.S. Cl. CPC G06F 3/0613; G06F 3/0659; G06F 3/0679

(57) ABSTRACT

A semiconductor memory device includes: a first pin usable for inputting and outputting data; a second pin usable for inputting and outputting data; a third pin to which a clock signal is input from a controller; a fourth pin; and a memory cell array including a string in which a plurality of memory cell transistors are connected in series. The semiconductor memory device is configured to be able to perform: a first data output method for outputting data from the second pin and outputting a strobe signal from the first pin in synchronization with the data according to the clock signal input to the third pin; and a second data output method for outputting data from the first pin and the second pin and outputting the strobe signal from the fourth pin in synchronization with the data according to the clock signal input to the third pin.

### CROSS-REFERENCE TO RELATED APPLICATIONS

This application is based upon and claims the benefit of Japanese Patent Application No. 2025-045627, filed on Mar. 19, 2025, the entire contents of which are incorporated herein by reference.

### BACKGROUND

### Field

Embodiments described herein relate generally to a semiconductor memory device and a controller.

### Description of the Related Art

There has been known a semiconductor memory device that includes a first pin and a second pin usable for inputting and outputting data, a third pin to which a clock signal is input from a controller, and a memory cell array including a string in which a plurality of memory cell transistors are connected in series.

### BRIEF DESCRIPTION OF THE DRAWINGS

FIG. 1 is a schematic block diagram illustrating a configuration of a memory system 10 according to a first embodiment;

FIG. 2 is a schematic block diagram illustrating a configuration of a memory system 10A according to the first embodiment;

FIG. 3A is a schematic side view, and FIG. 3B is a plan view, each illustrating an exemplary configuration of a package PKG;

FIG. 4 is a schematic side view illustrating an exemplary configuration of the memory system 10;

FIG. 5 is a schematic block diagram illustrating a configuration of a memory die MD;

FIG. 6 is a schematic circuit diagram illustrating a configuration of a part of the memory die MD;

FIG. 7 is a schematic perspective view illustrating a configuration of a part of the memory die MD;

FIG. 8 is a schematic circuit diagram illustrating a configuration of a part of the memory die MD;

FIG. 9 is a schematic circuit diagram illustrating a configuration of a part of the memory die MD;

FIG. 10 is a schematic view for describing a method for inputting a signal from a controller die CD to the memory die MD in the first embodiment;

FIG. 11 is a schematic waveform diagram for describing an operation of the memory die MD;

FIG. 12 is a schematic table for describing the operation of the memory die MD;

FIG. 13 is a schematic waveform diagram illustrating an input/output signal between the controller die CD and the memory die MD;

FIG. 14 is a schematic waveform diagram illustrating the input/output signal between the controller die CD and the memory die MD;

FIG. 15 is a schematic waveform diagram illustrating the input/output signal between the controller die CD and the memory die MD;

FIG. 16 is a schematic waveform diagram illustrating the input/output signal between the controller die CD and the memory die MD;

FIG. 17 is a schematic waveform diagram illustrating the input/output signal between the controller die CD and the memory die MD;

FIG. 18 is a schematic waveform diagram illustrating the input/output signal between the controller die CD and the memory die MD;

FIG. 19 is a schematic view for describing roles of signal input/output terminals and control terminals of the memory die MD in a working example;

FIG. 20 is a schematic waveform diagram illustrating the input/output signal between the controller die CD and the memory die MD in the working example;

FIG. 21 is a schematic waveform diagram illustrating the input/output signal between the controller die CD and the memory die MD in the working example;

FIG. 22 is a schematic waveform diagram illustrating the input/output signal between the controller die CD and the memory die MD in the working example;

FIG. 23 is a schematic view for describing a method for inputting a signal from the controller die CD to the memory die MD in a second embodiment; and

FIG. 24 is a schematic waveform diagram illustrating the input/output signal between the controller die CD and the memory die MD in the second embodiment.

### DETAILED DESCRIPTION

A semiconductor memory device according to one embodiment includes: a first pin usable for inputting and outputting data; a second pin usable for inputting and outputting data; a third pin to which a clock signal is input from a controller; a fourth pin; and a memory cell array including a string in which a plurality of memory cell transistors are connected in series. The semiconductor memory device is configured to be able to perform a first data output method and a second data output method. In the first data output method, data is output from the second pin and a strobe signal is output from the first pin in synchronization with the data according to the clock signal input to the third pin. In the second data output method, data is output from the first pin and the second pin and the strobe signal is output from the fourth pin in synchronization with the data according to the clock signal input to the third pin.

The memory systems according to embodiments are described below in detail with reference to the drawings. The following embodiments are only examples, and not described for the purpose of limiting the present invention. For convenience of description, a part of a configuration and the like is sometimes omitted. Parts common in a plurality of embodiments are attached by same reference numerals and their descriptions may be omitted.

In this specification, when referring to a “memory system”, it may mean a system including a memory die and a controller die, such as a memory card and a Solid State Drive (SSD). It may also mean a system including an I/F chip in addition to the controller die. Further, it may mean a configuration including a host computer, such as a smartphone, a tablet terminal, and a personal computer.

In this specification, when it is referred that a first configuration “is connected between” a second configuration and a third configuration, it may mean that the first configuration, the second configuration, and the third configuration are connected in series and the second configuration is connected to the third configuration via the first configuration.

In this specification, a direction parallel to an upper surface of a substrate is referred to as an X-direction, a direction parallel to the upper surface of the substrate and perpendicular to the X-direction is referred to as a Y-direction, and a direction perpendicular to the upper surface of the substrate is referred to as a Z-direction.

In this specification, when referring to a “width” or the like of a configuration, a member, or the like in a predetermined direction, this may mean a “width” or the like in a cross-sectional surface or the like observed with a Scanning Electron Microscopy (SEM), a Transmission Electron Microscopy (TEM), or the like.

### FIRST EMBODIMENT

### [Memory System 10]

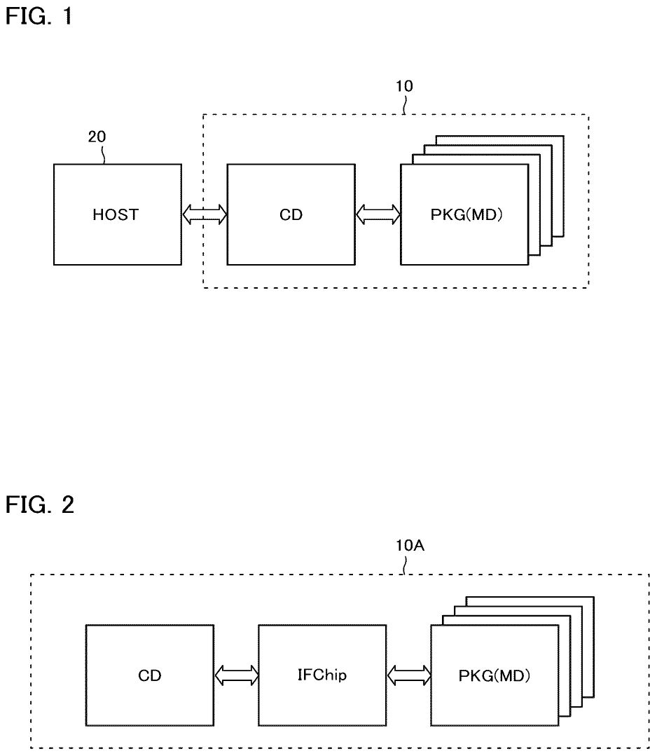

FIG. 1 is a schematic block diagram illustrating a configuration of a memory system 10 according to a first embodiment. FIG. 2 is a schematic block diagram illustrating a configuration of a memory system 10A according to the embodiment.

The memory system 10, for example, reads, writes, and erases user data according to a signal transmitted from a host computer 20. The memory system 10 is, for example, a memory card, an SSD, or another system that can store user data. The memory system 10 includes a plurality of packages PKG and a controller die CD connected to these plurality of packages PKG and the host computer 20. Each of the packages PKG includes a plurality of memory dies MD. Each of the memory dies MD can store the user data. The controller die CD includes, for example, a processor, a RAM, and the like, and performs conversion between a logical address and a physical address, bit error detection/correction, a garbage collection (compaction), a wear leveling, and the like.

The memory system 10 may be, as illustrated in FIG. 2, the memory system 10A that includes an interface chip IFChip between the plurality of packages PKG and the controller die CD. With the interface chip IFChip provided, the memory system 10A can reduce a load capacitance of a data bus when the plurality of packages PKG are connected to the controller die CD.

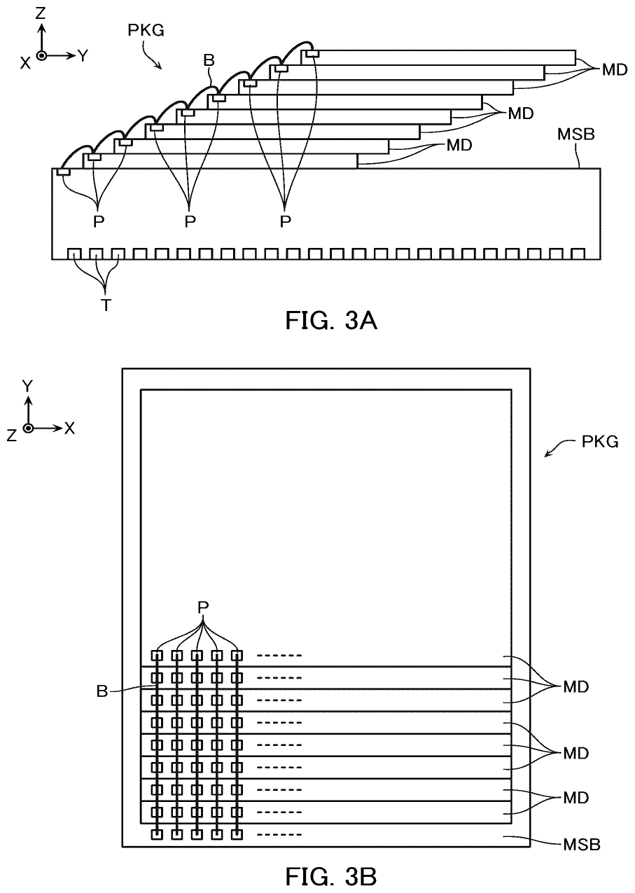

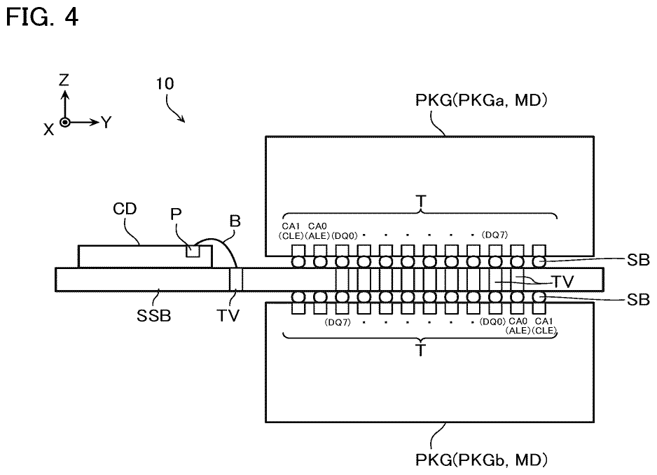

FIG. 3A and FIG. 3B are views illustrating an exemplary configuration of the package PKG included in the memory system 10 according to the embodiment. More specifically, FIG. 3A is a schematic side view illustrating the exemplary configuration of the package PKG, and FIG. 3B is a schematic plan view illustrating the exemplary configuration of the package PKG. FIG. 4 is a schematic side view illustrating an exemplary configuration of the memory system 10. For convenience of explanation, a part of configurations are omitted in FIG. 3A, FIG. 3B, and FIG. 4.

As illustrated in FIG. 3A, the package PKG according to the embodiment includes a memory die mounting substrate MSB and a plurality of memory dies MD stacked on the memory die mounting substrate MSB. A pad electrode P is disposed in a region at an end portion in the Y-direction of an upper surface of the memory die mounting substrate MSB, and a part of another region is bonded to a lower surface of the memory die MD via an adhesive and the like. A pad electrode P is disposed in a region at an end portion in the Y-direction of an upper surface of the memory die MD, and another region is bonded to a lower surface of another memory die MD via the adhesive and the like. The pad electrodes P corresponding in the plurality of memory dies MD are connected by a bonding wire B in common. Electrode terminals T are disposed on a lower surface of the memory die mounting substrate MSB. The pad electrodes P on the upper surface of the memory die mounting substrate MSB are connected to the respective electrode terminals T on the lower surface. The memory die mounting substrate MSB may be, for example, a grid array substrate. On the upper surface of the memory die mounting substrate MSB, the plurality of memory dies MD and the bonding wire B are, for example, covered with a sealing resin (not illustrated).

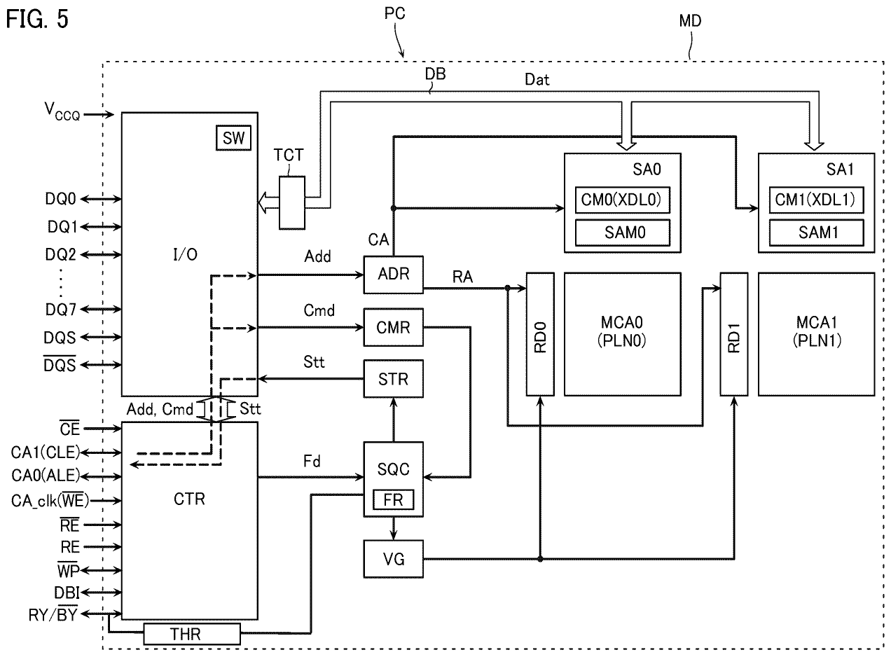

As illustrated in FIG. 3B, each of the memory die mounting substrate MSB and the plurality of memory dies MD includes a plurality of pad electrodes P arranged in the X-direction. The respective plurality of pad electrodes P of each memory die MD correspond to control terminals/CE, CA1 (CLE), CA0 (ALE), CA_clk (/WE), /RE, RE, and/WP, data signal input/output terminals DQ0 to DQ7, data strobe signal input/output terminals DQS, /DQS, a terminal DBI, and a terminal RY//BY described later with reference to FIG. 5. The control terminals/CE, CA1 (CLE), CA0 (ALE), CA_clk (/WE), /RE, RE, the terminal DBI, and the terminal RY//BY are referred to as a/CE pin, a CA1 (CLE) pin, a CA0 (ALE) pin, a CA_clk (/WE) pin, a/RE pin, an RE pin, a DBI pin, and an RY//BY pin in some cases.

The plurality of pad electrodes P disposed on the memory die mounting substrate MSB and the plurality of memory dies MD are mutually connected via the bonding wire B. For example, in the plurality of memory dies MD, the pad electrodes P corresponding to the control terminal CA1 (CLE) are mutually connected, and the pad electrodes P corresponding to the control terminal CA0 (ALE) are mutually connected. The same applies to the other terminals. The pad electrodes P of each of the memory dies MD in the package PKG are connected to the outside of the package PKG via the electrode terminals T on the lower surface of the memory die mounting substrate MSB.

FIG. 4 is a schematic side view illustrating an exemplary configuration of the memory system 10 according to the embodiment. The memory system 10 includes a system mounting substrate SSB, a plurality of packages PKG disposed on the system mounting substrate SSB, and a controller die CD. The controller die CD and a part of the packages PKG are disposed on an upper surface of the system mounting substrate SSB. Other packages PKG are disposed on a lower surface of the system mounting substrate SSB.

The controller die CD is provided with a plurality of the pad electrodes P. The pad electrodes P of the controller die CD are connected to the system mounting substrate SSB via the bonding wire B. Electrode terminals T of the plurality of packages PKG are connected to the system mounting substrate SSB via solder balls SB. The pad electrodes P of the controller die CD are connected to the electrode terminals T of the plurality of packages PKG by wirings (not illustrated) formed on the upper surface and the lower surface of the system mounting substrate SSB. The upper surface and the lower surface of the system mounting substrate SSB are connected by a through electrode TV.

A part of the electrode terminals T of the package PKG disposed on the upper surface of the system mounting substrate SSB may be connected to a part of the electrode terminals T of the package PKG disposed on the lower surface of the system mounting substrate SSB by the through electrodes TV. More specifically, the electrode terminals T corresponding to the data signal input/output terminals DQ0 to DQ7 of the package PKG disposed on the upper surface of the system mounting substrate SSB may be connected to the electrode terminals T corresponding to the data signal input/output terminal DQ0 to DQ7 of the package PKG disposed on the lower surface of the system mounting substrate SSB via the respective through electrodes TV.

When the packages PKG have the same configuration, for example, the electrode terminal T corresponding to the data signal input/output terminal DQ0 of one package PKG is connected to the electrode terminal T corresponding to the data signal input/output terminal DQ7 of the other package PKG (FIG. 4). Here, the one package PKG is referred to as a forward connection package PKGa and the other package PKG is referred to as a reverse connection package PKGb. The electrode terminals T corresponding to the data signal input/output terminals DQ1, DQ2, DQ3, DQ4, DQ5, DQ6, DQ7 of the forward connection package PKGa are connected to the electrode terminals T corresponding to the data signal input/output terminals DQ6, DQ5, DQ4, DQ3, DQ2, DQ1, DQ0 of the reverse connection package PKGb, respectively. This connection method is referred to as a mirror connection.

The electrode terminals T corresponding to the other control terminals are individually connected to the pad electrode P of the controller die CD. For example, the electrode terminal T corresponding to the control terminal CA1 (CLE) of the one package PKG (forward connection package PKGa) and the electrode terminal T corresponding to the control terminal CA1 (CLE) of the other package PKG (reverse connection package PKGb) are connected to the pad electrode P of the controller die CD by mutually different wirings. The electrode terminal T corresponding to the control terminal CA0 (ALE) of the one package PKG (forward connection package PKGa) and the electrode terminal T corresponding to the control terminal CA0 (ALE) of the other package PKG (reverse connection package PKGb) are connected to the pad electrode P of the controller die CD by mutually different wirings.

The configuration illustrated in FIG. 3A, FIG. 3B, and FIG. 4 is only an example, and the specific configuration can be adjusted as appropriate. For example, in the example illustrated in FIG. 3A and FIG. 3B, a plurality of the memory dies MD are stacked, and these configurations are connected by the bonding wires B. However, the plurality of memory dies MD may be mutually connected via through electrodes or the like instead of the bonding wires B. In the example illustrated in FIG. 4, the electrode terminals T (data signal input/output terminals DQ0 to DQ7) of the packages PKG disposed on the upper and lower surfaces of the system mounting substrate SSB are mirror-connected by the through electrodes TV. However, the electrode terminals T (data signal input/output terminals DQ0 to DQ7) of the packages PKG do not need to be mirror-connected. The controller die CD may be disposed in the same package as one or a plurality of the memory dies MD.

### [Configuration of Memory Die MD]

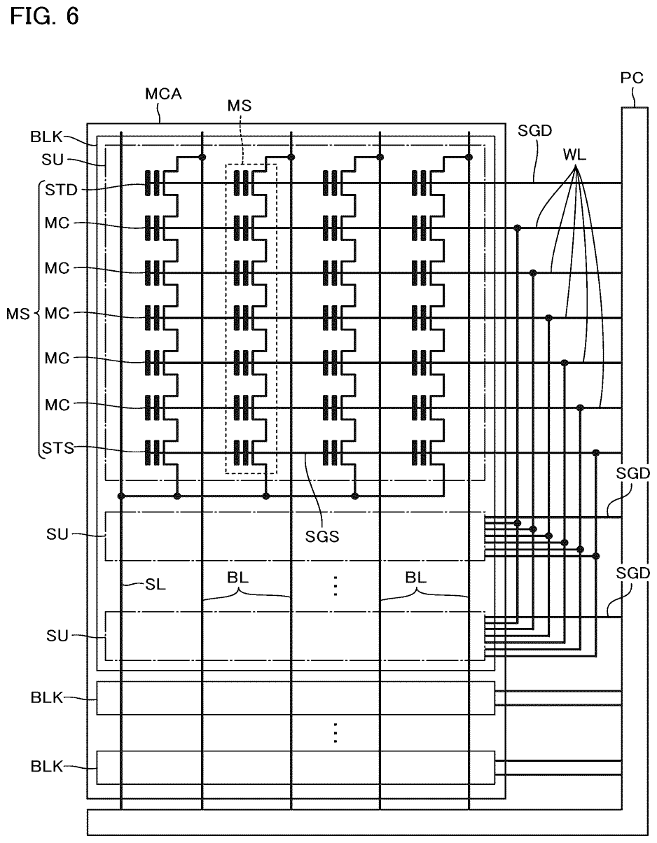

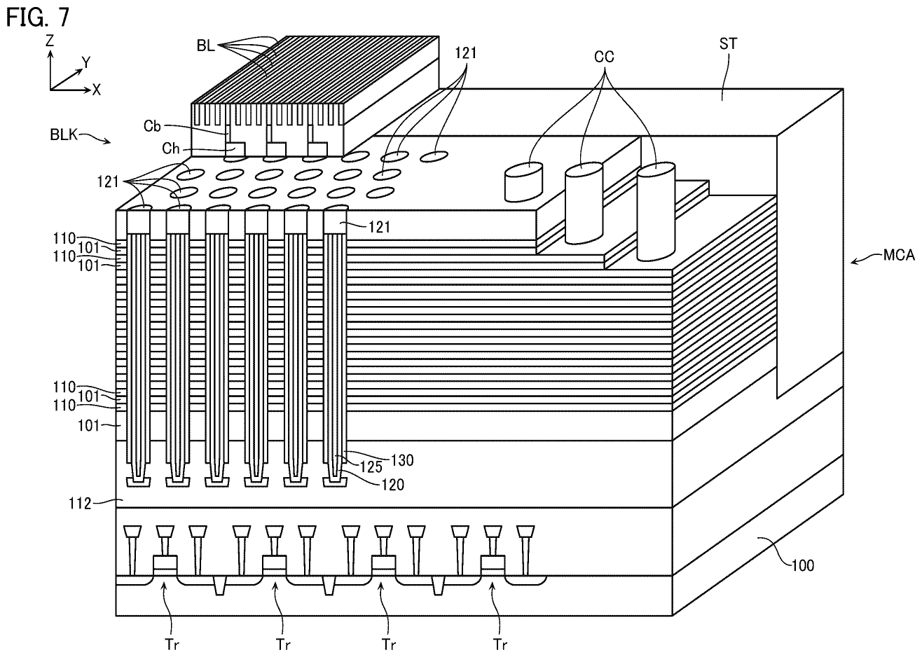

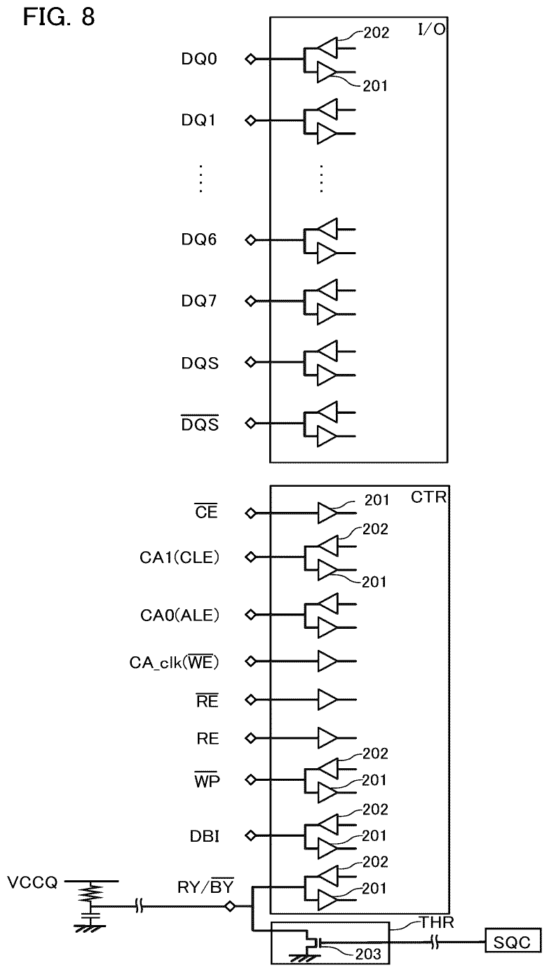

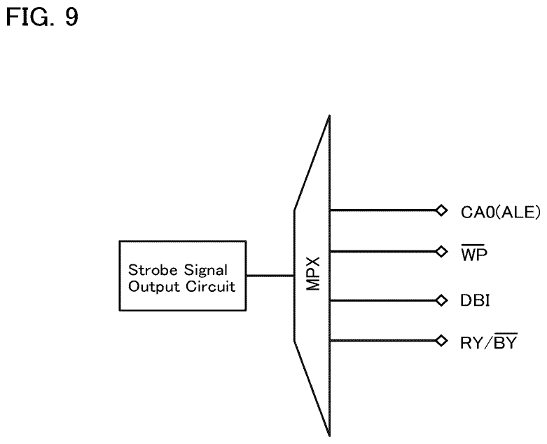

FIG. 5 is a schematic block diagram illustrating a configuration of the memory die MD according to the embodiment. FIG. 6 is a schematic circuit diagram illustrating a configuration of a part of the memory die MD. FIG. 7 is a schematic perspective view illustrating a configuration of a part of the memory die MD. FIG. 8 and FIG. 9 are schematic circuit diagrams illustrating configurations of a part of the memory die MD. For convenience of explanation, a part of the configurations are omitted in FIG. 5 to FIG. 9.

FIG. 5 illustrates a plurality of control terminals and the like. These plurality of control terminals (a plurality of pins)are represented as control terminals corresponding to a high active signal (positive logic signal) in some cases, represented as control terminals corresponding to a low active signal (negative logic signal) in some cases, and represented as control terminals corresponding to both the high active signal and the low active signal in some cases. In FIG. 5, a reference sign of the control terminal corresponding to the low active signal includes an overline (overbar). In this specification, a reference sign of the control terminal corresponding to the low active signal includes a slash (“/”). The description of FIG. 5 is an example, and specific aspects are appropriately adjustable. For example, a part of or all of the high active signals can be changed to the low active signals, or a part of or all of the low active signals can be changed to the high active signals.

At sides of the plurality of control terminals (the plurality of pins) illustrated in FIG. 5, arrows indicating input/output directions are illustrated. In FIG. 5, the control terminals (pins) with left-right arrows are usable for inputting data or other signals from the controller die CD to the memory die MD. In FIG. 5, the control terminals (pins) with right-left arrows are usable for outputting data or other signals from the memory die MD to the controller die CD. In FIG. 5, the control terminals (pins) with left-right double arrows are usable for both of inputting data or other signals from the controller die CD to the memory die MD and outputting data or other signals from the memory die MD to the controller die CD.

As illustrated in FIG. 5, the memory die MD includes memory cell arrays MCA0, MCA1 storing user data, and a peripheral circuit PC connected to the memory cell arrays MCA0, MCA1. In the following description, the memory cell arrays MCA0, MCA1 are referred to as a memory cell array MCA in some cases. The memory cell arrays MCA0, MCA1 are referred to as planes PLN0, PLN1 in some cases.

### [Configuration of Memory Cell Array MCA]

As illustrated in FIG. 6, the memory cell array MCA includes a plurality of memory blocks BLK. These plurality of memory blocks BLK each include a plurality of string units SU. These plurality of string units SU each include a plurality of memory strings MS. These plurality of memory strings MS have one ends each connected to the peripheral circuit PC via bit lines BL. Furthermore, these plurality of memory strings MS have the other ends each connected to the peripheral circuit PC via a common source line SL.

The memory string MS includes a drain-side select transistor STD, a plurality of memory cells MC (memory cell transistors), and a source-side select transistor STS, which are connected in series between the bit line BL and the source line SL. Hereinafter, the drain-side select transistor STD and the source-side select transistor STS may be simply referred to as select transistors (STD, STS).

The memory cell MC is a field-effect type transistor (memory cell transistor) including a semiconductor layer, a gate insulating film, and a gate electrode. The semiconductor layer functions as a channel region. The gate insulating film includes an electric charge accumulating film. The memory cell MC has a threshold voltage that changes according to an electric charge amount in the electric charge accumulating film. The memory cell MC stores one bit or a plurality of bits of data. Word lines WL are connected to the respective gate electrodes of the plurality of memory cells MC corresponding to one memory string MS. These respective word lines WL are connected to all of the memory strings MS in one memory block BLK in common.

The select transistors (STD, STS) are field-effect type transistors each including a semiconductor layer, a gate insulating film, and a gate electrode. The semiconductor layer functions as a channel region. A drain-side select gate line SGD and a source-side select gate line SGS are connected to the gate electrodes of the select transistors (STD, STS), respectively. The drain-side select gate line SGD is disposed corresponding to the string unit SU and connected to all of the memory strings MS in one string unit SU in common. The source-side select gate line SGS is connected to all of the memory strings MS in the memory block BLK in common. Hereinafter, the drain-side select gate line SGD and the source-side select gate line SGS may be simply referred to as select gate lines (SGD, SGS).

For example, as illustrated in FIG. 7, the memory cell array MCA is disposed above a semiconductor substrate 100. In the example in FIG. 7, between the semiconductor substrate 100 and the memory cell array MCA, a plurality of transistors Tr constituting the peripheral circuit PC are disposed.

The memory cell array MCA includes a plurality of memory blocks BLK arranged in the Y-direction. Between two memory blocks BLK adjacent to one another in the Y-direction, an inter-block insulating layer ST of silicon oxide (SiO₂) or the like is disposed.

For example, as illustrated in FIG. 7, the memory block BLK includes a plurality of conductive layers 110 arranged in the Z-direction, a plurality of semiconductor columns 120 extending in the Z-direction, and a respective plurality of gate insulating films 130 disposed between the plurality of conductive layers 110 and the plurality of semiconductor columns 120.

The conductive layer 110 is an approximately plate-shaped conductive layer extending in the X-direction. The conductive layer 110 may include a stacked film of a barrier conductive film of titanium nitride (TiN) or the like, and a metal film of tungsten (W) or the like, or the like. For example, the conductive layer 110 may contain polycrystalline silicon containing impurities, such as phosphorus (P) or boron (B), or the like. Insulating layers 101 of silicon oxide (SiO₂) or the like are disposed between the plurality of conductive layers 110 arranged in the Z-direction.

Among the plurality of conductive layers 110, one or a plurality of conductive layers 110 positioned at the lowermost layer function as the source-side select gate line SGS (FIG. 6) and gate electrodes of the plurality of source-side select transistors STS connected to the source-side select gate line SGS. These plurality of conductive layers 110 are electrically independent in every memory block BLK.

A plurality of conductive layers 110 positioned above these conductive layers 110 function as the word lines WL (FIG. 6) and gate electrodes of the plurality of memory cells MC (FIG. 6) connected to the word lines WL. These plurality of conductive layers 110 are each electrically independent in every memory block BLK.

One or a plurality of conductive layers 110 positioned above these conductive layers 110 function as the drain-side select gate line SGD and gate electrodes of the plurality of drain-side select transistors STD (FIG. 6) connected to the drain-side select gate line SGD. These plurality of conductive layers 110 have widths in the Y-direction smaller than those of other conductive layers 110.

A semiconductor layer 112 is disposed below the conductive layer 110. The semiconductor layer 112 may contain, for example, polycrystalline silicon containing impurities such as phosphorus (P)or boron (B), or the like. Between the semiconductor layer 112 and the conductive layer 110, an insulating layer 101 of silicon oxide (SiO₂) or the like is disposed.

The semiconductor layer 112 functions as the source line SL (FIG. 6). The source line SL is disposed in common, for example, for all the memory blocks BLK included in the memory cell array MCA.

For example, as illustrated in FIG. 7, the semiconductor columns 120 are arranged in the X-direction and the Y-direction in a predetermined pattern. The semiconductor columns 120 function as the channel regions of the plurality of memory cells MC and the select transistors (STD, STS) included in one memory string MS (FIG. 6). The semiconductor column 120 is, for example, a semiconductor layer of polycrystalline silicon (Si) or the like. For example, as illustrated in FIG. 7, the semiconductor column 120 has an approximately closed-bottomed cylindrical shape and includes an insulating layer 125 of silicon oxide or the like, in a center part. The semiconductor column 120 has an outer peripheral surface that is surrounded by each of the conductive layers 110 and is opposed to the conductive layers 110.

In the upper end portion of the semiconductor column 120, an impurity region 121 containing N-type impurities, such as phosphorus (P), is disposed. The impurity region 121 is connected to the bit line BL via a contact Ch and a contact Cb.

The gate insulating film 130 has an approximately closed-bottomed cylindrical shape that covers the outer peripheral surface of the semiconductor column 120. The gate insulating film 130 includes, for example, a tunnel insulating film, an electric charge accumulating film, and a block insulating film, which are stacked between the semiconductor column 120 and the conductive layers 110. The tunnel insulating film and the block insulating film are, for example, insulating films of silicon oxide (SiO₂) or the like. The electric charge accumulating film is, for example, a film that can accumulate the electric charges of silicon nitride (Si₃N₄) or the like. The tunnel insulating film, the electric charge accumulating film, and the block insulating film have approximately cylindrical shapes and extend in the Z-direction along the outer peripheral surface of the semiconductor column 120 excluding the contact portion between the semiconductor column 120 and the semiconductor layer 112.

The gate insulating film 130 may, for example, include a floating gate of polycrystalline silicon including N-type or P-type impurities, or the like.

The plurality of conductive layers 110 have end portions in the X-direction where a plurality of contacts CC are disposed. The plurality of conductive layers 110 are connected to the peripheral circuit PC via these plurality of contacts CC. As illustrated in FIG. 7, these plurality of contacts CC extend in the Z-direction, and have lower ends connected to the conductive layers 110. The contacts CC may, for example, include a stacked film of a barrier conductive film of titanium nitride (TiN) or the like and a metal film of tungsten (W) or the like, or the like.

### [Configuration of Peripheral Circuit PC]

For example, as illustrated in FIG. 5, the peripheral circuit PC includes row decoders RD0, RD1 and sense amplifiers SA0, SA1, which are connected to the memory cell arrays MCA0, MCA1, respectively. The peripheral circuit PC includes a voltage generation circuit VG and a sequencer SQC. The peripheral circuit PC includes an input/output control circuit I/O, a logic circuit CTR, an address register ADR, a command register CMR, a status register STR, and a data output timing adjustor TCT. In the following description, the row decoders RD0, RD1 are referred to as a row decoder RD, and the sense amplifiers SA0, SA1 are referred to as a sense amplifier SA, in some cases.

### [Configuration of Row Decoder RD]

The row decoder RD (FIG. 5) includes an address decoder decoding address data Add. The row decoder RD (FIG. 5) includes a block select circuit and a voltage select circuit to select one of the plurality of memory blocks BLK according to an output signal of the address decoder and transfer an operating voltage to the word line WL included in the selected memory blocks BLK.

### [Configuration of Sense Amplifier SA]

The sense amplifiers SA0, SA1 (FIG. 5) include the sense amplifier modules SAM0, SAM1 and the cache memories CM0, CM1, respectively. The cache memories CM0, CM1 include latch circuits XDL0, XDL1, respectively.

In the following description, the sense amplifier modules SAM0, SAM1 are referred to as a sense amplifier module SAM, the cache memories CM0, CM1 are referred to as a cache memory CM, and the latch circuits XDL0, XDL1 are referred to as a latch circuit XDL, in some cases.

For example, the sense amplifier module SAM includes sense circuits corresponding to the respective plurality of bit lines BL, and a plurality of latch circuits connected to the sense circuits, and the like.

The cache memory CM includes a plurality of latch circuits XDL. The plurality of latch circuits XDL are each connected to the latch circuit inside the sense amplifier module SAM. In the latch circuit XDL, for example, user data Dat written into the memory cell MC or user data Dat read out from the memory cell MC is stored.

A column decoder (not illustrated) is connected to the cache memory CM. The column decoder decodes a column address CA stored in the address register ADR (FIG. 5) and selects the latch circuit XDL corresponding to the column address CA.

The user data Dat included in these plurality of latch circuits XDL is sequentially transferred to the latch circuits inside the sense amplifier modules SAM in the write operation. The user data Dat included in the latch circuits inside the sense amplifier modules SAM is sequentially transferred to the latch circuits XDL in the read operation. The user data Dat included in the latch circuits XDL is sequentially transferred to the input/output control circuit I/O in a data-out operation.

### [Configuration of Voltage Generation Circuit VG]

The voltage generation circuit VG (FIG. 5) includes, for example, a step-down circuit and a step-up circuit. The step-down circuit is, for example, a regulator. The step-up circuit is, for example, a charge pump circuit. These step-down circuit and step-up circuit are each connected to a power supply voltage supply line. These voltage supply lines are connected to, for example, the pad electrodes P described with reference to FIG. 3A, FIG. 3B, and FIG. 4. For example, the voltage generation circuit VG generates a plurality of operating voltages applied to the bit line BL, the source line SL, the word line WL, and the select gate lines (SGD, SGS) in the read operation, the write operation, and the erase operation on the memory cell array MCA, in accordance with a control signal from the sequencer SQC to simultaneously output the operating voltages to the plurality of voltage supply lines. The operating voltage output from the voltage supply line is appropriately adjusted in accordance with the control signal from the sequencer SQC.

### [Configuration of Sequencer SQC]

The sequencer SQC (FIG. 5) outputs an internal control signal to the row decoders RD0, RD1, the sense amplifier modules SAM0, SAM1, and the voltage generation circuit VG in response to command data Cmd stored in the command register CMR. The sequencer SQC outputs status data Stt indicating the state of the memory die MD to the status register STR as appropriate. The state of the memory die MD includes a ready/busy state of the memory die MD. Hereinafter, the ready/busy state is simply referred to as a “ready-busy state” in some cases.

The sequencer SQC generates a ready/busy signal and outputs the ready/busy signal to a terminal RY//BY via a circuit THR. For example, the terminal RY//BY enters an “L” state during the operations, such as a read operation, a write operation, and an erase operation, where the voltage is applied to the memory cell array MCA and execution of a get feature (Get Feature), a set feature (Set Feature), and the like, which is described later, and enters an “H” state in the other cases. Even when the operations, such as a data-out operation and a status read, where the voltage is not applied to the memory cell array MCA are executed, the terminal RY//BY does not enter the “L” state. In a period where the terminal RY//BY is in the “L” state (a busy period), an access to the memory die MD is basically inhibited. In a period where the terminal RY//BY is in the “H” state (a ready period), the access to the memory die MD is permitted. The terminal RY//BY is achieved by, for example, the pad electrode P described with reference to FIG. 3A, FIG. 3B, and FIG. 4.

The sequencer SQC includes a feature register FR. The feature register FR (FIG. 5) is a register that latches feature data Fd. The feature data Fd includes, for example, control parameters of the memory die MD, or the like.

### [Configuration of Address Register ADR]

The address register ADR (FIG. 5) is connected to the input/output control circuit I/O and stores the address data Add input from the input/output control circuit I/O. The address register ADR includes, for example, a plurality of 8-bit register arrays. For example, when an internal operation, such as a read operation, a write operation, or an erase operation, is executed, the register array latches the address data Add corresponding to the internal operation in execution.

The address data Add includes, for example, the column address CA (FIG. 5) and the row address RA (FIG. 5). The row address RA includes, for example, a block address identifying the memory block BLK (FIG. 6), a page address identifying the string unit SU and the word line WL, a plane address identifying the memory cell array MCA (the plane), and a chip address identifying the memory die MD.

### [Configuration of Command Register CMR]

The command register CMR (FIG. 5) is connected to the input/output control circuit I/O and stores the command data Cmd input from the input/output control circuit I/O. For example, the command register CMR includes at least one set of an 8-bit register array. When the command data Cmd is stored in the command register CMR, the control signal is transmitted to the sequencer SQC.

### [Configuration of Status Register STR]

The status register STR (FIG. 5) is connected to the input/output control circuit I/O and stores the status data Stt output to the input/output control circuit I/O. For example, the status register STR includes a plurality of 8-bit register arrays. For example, when the internal operation, such as a read operation, a write operation, or an erase operation, is performed, the register array latches the status data Stt regarding the internal operation in execution. The register array, for example, latches ready/busy information indicative of the ready-busy state of the memory cell arrays MCA0, MCA1.

### [Configuration of Data Output Timing Adjustor TCT]

The data output timing adjustor TCT is connected to a bus wiring DB between the cache memories CM0, CM1 and the input/output control circuit I/O. For example, in a case where the data-out operation is continuously executed with respect to the cache memories CM0, CM1, or the like, in order to start the data-out operation of the cache memory CM1 in no time after completion of the data-out operation of the cache memory CM0, the data output timing adjustor TCT adjusts a start timing of the data-out operation with respect to the cache memory CM1.

### [Configuration of Input/Output Control Circuit I/O]

The input/output control circuit I/O (FIG. 5) includes data signal input/output terminals DQ0 to DQ7, data strobe signal input/output terminals DQS, /DQS, a shift register, a buffer circuit, and a connection change circuit SW.

Each of the data signal input/output terminals DQ0 to DQ7 and the data strobe signal input/output terminals DQS, /DQS is achieved, for example, by the pad electrode P described with reference to FIG. 3A, FIG. 3B, and FIG. 4. Data input via the data signal input/output terminals DQ0 to DQ7 is input to the cache memory CM from the buffer circuit, corresponding to an internal control signal from the logic circuit CTR. Data output via the data signal input/output terminals DQ0 to DQ7 is input to the buffer circuit from the cache memory CM or the status register STR, corresponding to the internal control signal from the logic circuit CTR.

Signals (for example, a data strobe signal and its complementary signal) input via the data strobe signal input/output terminals DQS, /DQS are used in inputting data via the data signal input/output terminals DQ0 to DQ7. The data input via the data signal input/output terminals DQ0 to DQ7 is retrieved inside the shift register inside the input/output control circuit I/O, at timings of a voltage rise edge of the data strobe signal input/output terminal DQS and a voltage fall edge of the data strobe signal input/output terminal /DQS and at timings of the voltage fall edge of the data strobe signal input/output terminal DQS and the voltage rise edge of the data strobe signal input/output terminal /DQS.

Each of the data signal input/output terminals DQ0 to DQ7 and the data strobe signal input/output terminals DQS, /DQS is, for example, as illustrated in FIG. 8, connected to an input circuit 201 and an output circuit 202. The input circuit 201 is, for example, a receiver made of a comparator or the like. The output circuit 202 is, for example, a driver, such as an Off Chip Driver (OCD) circuit.

The connection change circuit SW (FIG. 5) is a circuit that retrieves data input to the data signal input/output terminals DQ0 to DQ7 from the outside of the memory die MD into the memory die MD by changing the order of the data.

Each of the memory dies MD determines, for example, whether the memory die MD is included in the forward connection package PKGa or included in the reverse connection package PKGb based on the feature data Fd stored in the feature register FR.

### [Configuration of Logic Circuit CTR]

The logic circuit CTR (FIG. 5) includes the plurality of control terminals/CE, CA1 (CLE), CA0 (ALE), CA_clk (/WE), /RE, RE, /WP, the terminal DBI, and the terminal RY//BY, and logic circuits connected to these plurality of control terminals/CE, CA1 (CLE), CA0 (ALE), CA_clk (/WE), /RE, RE, /WP, the terminal DBI, and the terminal RY//BY. The logic circuit CTR receives external control signals from the controller die CD via the control terminals/CE, CA1 (CLE), CA0 (ALE), CA_clk (/WE), /RE, RE, and outputs internal control signals to the input/output control circuit I/O according to the external control signals. The logic circuit CTR can receive the external control signals from the controller die CD via the control terminals/WP, the terminal DBI, or the terminal RY//BY, and output the internal control signals to the input/output control circuit I/O according to the external control signals corresponding to the setting.

Each of the control terminals/CE, CA1 (CLE), CA0 (ALE), CA_clk (/WE), /RE, RE, /WP, the terminal DBI, and the terminal RY//BY is, for example, as illustrated in FIG. 8, connected to the input circuit 201. Each of the control terminals CA1 (CLE), CA0 (ALE), /WP, the terminal DBI, and the terminal RY//BY is also connected to the output circuit 202 in addition to the input circuit 201. Each of the control terminals/CE, CA1 (CLE), CA0 (ALE), CA_clk (/WE), /RE, RE, /WP, the terminal DBI, and the terminal RY//BY is achieved by, for example, the pad electrode P described with reference to FIG. 3A, FIG. 3B, and FIG. 4. The terminal RY//BY is applied with a power supply voltage V_{CCQ} from the outside of the memory die MD via a resistor element disposed outside the memory die MD. The terminal RY//BY is connected to a grounding terminal disposed outside the memory die MD via a capacitor disposed outside the memory die MD. The terminal RY//BY is connected to the circuit THR. The circuit THR includes, for example, a sinker transistor 203. The sinker transistor 203 is, for example, a field-effect type NMOS transistor. In the sinker transistor 203, a drain electrode is connected to the terminal RY//BY, a gate electrode is connected to the sequencer SQC, and a source electrode is grounded.

The signal (for example, a chip enable signal) input via the control terminal /CE is used in selection of the memory die MD. The memory die MD where “L” is input to the control terminal /CE enters a state where the input and output of the user data Dat, the command data Cmd, the address data Add, and the status data Stt (hereinafter simply referred to as “data” in some cases) are possible. The memory die MD where “H” is input to the control terminal /CE enters a state where the input and output of the data are impossible. As illustrated in FIG. 8, the control terminal /CE is connected to the input circuit 201.

The signal (for example, a command latch enable signal) input via the control terminal CA1 (CLE) is used in use of the command register CMR and the like. The signal input via the control terminal CA1 (CLE) is used in use of the command register CMR and the like, and is also used as the command data Cmd and the address data Add. Further, the status data Stt is output from the status register STR via the control terminal CA1 (CLE). In this embodiment, a signal including time-divisionally input two sets or more of data is input to the memory die MD from the controller die CD via the control terminal CA1 (CLE) and the control terminal CA0 (ALE). The time-divisionally input two sets or more of data is acquired by a signal input via the control terminal CA1 (CLE) and the control terminal CA0 (ALE) at timings of a voltage rise edge (for example, switching from the “L” state to the “H” state) of the control terminal CA_clk (/WE) and a voltage fall edge (for example, switching from the “H” state to the “L” state) of the control terminal CA_clk (/WE) described later. The function of the control terminal CA1 (CLE) and the like are described later.

The signal (for example, an address latch enable signal) input via the control terminal CA0 (ALE) is used in use of the address register ADR and the like. The signal input via the control terminal CA0 (ALE) is used in use of the address register ADR and the like, and is also used as the command data Cmd and the address data Add. Further, the status data Stt is output from the status register STR via the control terminal CA0 (ALE). The function of the control terminal CA0 (ALE) and the like are described later.

The signal (for example, a write enable signal) input via the control terminal CA_clk (/WE) is used in inputting the data to the memory die MD from the controller die CD and the like. The function of the control terminal CA_clk (/WE) and the like are described later.

The signals (for example, a read enable signal and its complementary signal) input via the control terminals /RE, RE are used in outputting data via the data signal input/output terminals DQ0 to DQ7. The data output from the data signal input/output terminals DQ0 to DQ7 is switched at timings of the voltage fall edge of the control terminal /RE and the voltage rise edge of the control terminal RE, and at timings of the voltage rise edge of the control terminal /RE and the voltage fall edge of the control terminal RE.

The signal (for example, a write protect signal) input via the control terminal /WP is used in restricting the input of the user data Dat to the memory die MD from the controller die CD and the like.

However, the function of the control terminal /WP can be switched according to the setting. For example, the signal input via the control terminal /WP may be used also as the command data Cmd and the address data Add, and the status data Stt may be output from the status register STR via the control terminal /WP. In this embodiment, the strobe signal can be output to the controller die CD from the memory die MD via the control terminal /WP. Not limited to the case where the strobe signal is output via the control terminal /WP, the strobe signal may be output via the terminal DBI or the terminal RY//BY according to the setting.

The terminal DBI (Data Bus Inversion) is an auxiliary terminal used for data transfer to reduce a data change rate. For example, when inputting the data via the data signal input/output terminals DQ0 to DQ7, frequent switching between “1” and “0” at the data signal input/output terminals DQ0 to DQ7 increases the power consumption of the input/output control circuit I/O. Here, the terminal DBI inverts “1” and “0” of the signal input via the data signal input/output terminals DQ0 to DQ7. This allows reducing the data change rates at the data signal input/output terminals DQ0 to DQ7 to decrease the power consumption of the input/output control circuit I/O.

However, the function of the terminal DBI can be switched according to the setting. For example, the signal input via the terminal DBI may be used also as the command data Cmd and the address data Add, and the status data Stt may be output from the status register STR via the terminal DBI.

In this embodiment, the function of the terminal RY//BY can be switched according to the setting as well. For example, the signal input via the terminal RY//BY may be used also as the command data Cmd and the address data Add, and the status data Stt may be output from the status register STR via the terminal RY//BY.

FIG. 9 is a schematic circuit diagram illustrating a configuration of a part of the memory die MD. When outputting the status data Stt, the feature data Fd, ID, and the like, the memory die MD outputs the strobe signal together with these pieces of data. This strobe signal indicates switching of bits of the status data Stt, the feature data Fd, ID, and the like. The ID is, for example, ID unique to the memory die MD and ID indicating a manufacturing lot of the memory die. As illustrated in FIG. 9, the memory die MD includes a strobe signal output circuit for outputting the strobe signal, and a multiplexer MPX to which the strobe signal output from the strobe signal output circuit is input. The multiplexer MPX has output terminals connected to the control terminal CA0 (ALE), the control terminal /WP, the terminal DBI, and the terminal RY//BY. In this embodiment, the output destination of the strobe signal output from the strobe signal output circuit can be set (assigned) to the control terminal CA0 (ALE), the control terminal /WP, the terminal DBI, or the terminal RY//BY by the multiplexer MPX. In this embodiment, in a normal mode, the output destination of the strobe signal output from the strobe signal output circuit is set to the control terminal CA0 (ALE). Meanwhile, in a data-out mode in a working example described later, the output destination of the strobe signal output from the strobe signal output circuit is set to the control terminal /WP.

[Method for Inputting Signal from Controller Die CD to Memory Die MD]

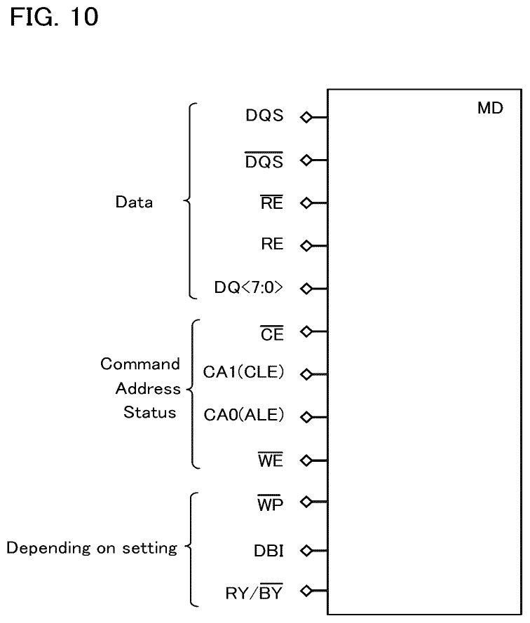

With reference to FIG. 10 to FIG. 18, a method for inputting a signal from the controller die CD to the memory die MD according to the embodiment is described.
[Roles of Respective Terminals]

FIG. 10 is a schematic view for describing the roles of the signal input/output terminals and the control terminals in the memory die MD. In the following description, the data signal input/output terminals DQ0 to DQ7 are expressed as data signal input/output terminals DQ<7:0> in some cases.

For example, as illustrated in FIG. 10, the memory die MD according to the embodiment uses the data signal input/output terminals DQ<7:0> for the input and output of the user data Dat, and does not use the data signal input/output terminals DQ<7:0> for the input of the command data Cmd and the address data Add, and the output of the status data Stt. In the memory die MD according to the embodiment, the control terminals CA1 (CLE), CA0 (ALE) are used for the input of the command data Cmd and the address data Add and the output of the data, such as status data Stt, and the control terminal /WE is used for the input of a clock signal transmitted from the controller die CD at the input/output of these pieces of data. The memory die MD according to the embodiment can use one of the control terminal /WP, the terminal DBI, and the terminal RY//BY for the output of the strobe signal according to the setting.

A part of the signal input and output via the control terminals CA1 (CLE), CA0 (ALE) of the memory die MD according to the embodiment may be referred to as a header. A set of the headers constituting the signal may be referred to as a header set. The header set includes a 4-bit signal time-divisionally input in two cycles in the operation of the memory die MD.

A part of the command data Cmd, the address data Add, the status data Stt, the feature data Fd, the ID, or the like input/output following the header may be referred to as a body. A set of the bodies constituting the data or a part of the data may be referred to as a body set. The body set includes 8-bit data time-divisionally input in four cycles during the operation in the normal mode of the memory die MD.

A set of one header set and one body set may be referred to as a frame.

The data of the control terminals CA1 (CLE), CA0 (ALE) is retrieved into a register (not illustrated) of the logic circuit CTR at the timings of a rise edge and a fall edge of the clock signal input to the control terminal /WP. That is, the data of the control terminals CA1 (CLE), CA0 (ALE) is retrieved into the register (not illustrated) of the logic circuit CTR corresponding to a toggle of the clock signal input to the control terminal CA_clk (/WE). In this specification, it is defined as a first cycle that the voltage of the clock signal input to the control terminal CA_clk (/WE) rises or falls once and 2-bit data is input via the control terminals CA1 (CLE), CA0 (ALE) corresponding to this voltage rise/fall. Similarly, it is defined as the first cycle that the voltage of the strobe signal input to the control terminal CA0 (ALE) or a control terminal CA_DOSTR (/WP) rises or falls once and 1-bit or 2-bit data is output via the control terminals CA1 (CLE), CA0 (ALE) corresponding to this voltage rise/fall. Further, it is defined as a second cycle that when the voltage of the clock signal input to the control terminal CA_clk (/WE) rises once and further falls, 4-bit data is input via the control terminals CA1 (CLE), CA0 (ALE) corresponding to this rise and fall of the voltage. Similarly, it is defined as the second cycle that, for example, when the voltage of the strobe signal input to the control terminal CA0 (ALE) or the control terminal CA_DOSTR (/WP) rises once and further falls, 2-bit or 4-bit data is output via at least one of the control terminals CA1 (CLE), CA0 (ALE) corresponding to this rise and fall of the voltage.

### [Exemplary Header Set Input in Normal Mode]

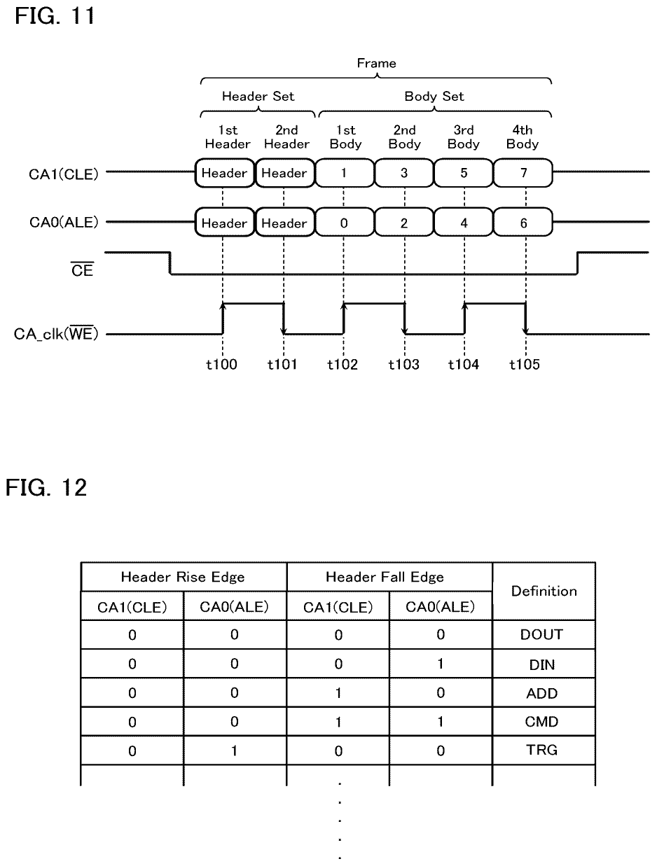

FIG. 11 is a schematic waveform diagram for describing an operation of the memory die MD according to the embodiment. FIG. 12 is a schematic table for describing the operation of the memory die MD.

FIG. 11 illustrates the waveform when the header set is input during the operation in the normal mode of the memory die MD. In the example of FIG. 11, in a state where the signal in the “L” state is input to the control terminal /CE, the signal in the “L” state and the signal in the “H” state are input to the control terminal CA_clk (/WE) at an approximately constant pace. That is, the input signal to the control terminal /CE is in the “L” state, and for the input signal to the control terminal CA_clk (/WE), switching of the input signal including rising from “L” to “H” once and falling from “H” to “L” (two toggles) is repeated.

In the example of FIG. 11, at timing t100 and timing t101, a 4-bit header set is input corresponding to the rise edge and the fall edge of the signal (clock signal) input to the control terminal CA_clk (/WE). More specifically, at timing t100 and timing t101, the controller die CD inputs the 4-bit header set illustrated in FIG. 11 to the memory die MD by two bits in two cycles. For example, when the input of the 8-bit command data Cmd in the body set is instructed, for the header in the first cycle, the voltage of the control terminals CA1 (CLE), CA0 (ALE) is set corresponding to the bits “0”, “0”, and the header in the first cycle is retrieved into the register (not illustrated) of the logic circuit CTR at the timing of raising the control terminal CA_clk (/WE) from “L” to “H” (rise edge). For the header in the second cycle, the voltage of the control terminals CA1 (CLE), CA0 (ALE) is set corresponding to the bits “1”, “1”, and the header in the second cycle is retrieved into the register (not illustrated) of the logic circuit CTR at the timing of falling the control terminal CA_clk (/WE) from “H” to “L” (fall edge).

In the example of FIG. 11, at timing t102 to timing t105, an 8-bit body set is input corresponding to the rise edge and the fall edge of the signal (clock signal) input to the control terminal CA_clk (/WE). More specifically, at timing t102 to timing t105, the controller die CD inputs the 8-bit body set corresponding to the 4-bit header set (entry condition) to the memory die MD by two bits in four cycles. For example, assume that the 8-bit command data Cmd has the bits “0” to “7”. First, for the body (data) in the first cycle, the voltage of the control terminals CA1 (CLE), CA0 (ALE) is set corresponding to the bits “1”, “0”, and the body (data) in the first cycle is retrieved at the timing of raising the control terminal CA_clk (/WE) from “L” to “H” (rise edge). For the body (data) in the second cycle, the voltage of the control terminals CA1 (CLE), CA0 (ALE) is set corresponding to the bits “3”, “2”, and the body (data) in the second cycle is retrieved at the timing of falling the control terminal CA_clk (/WE) from “H” to “L” (fall edge). The same applies to the bodies in a third cycle and a fourth cycle, the voltage of the control terminals CA1 (CLE), CA0 (ALE) is set corresponding to the bits “5”, “4” and the bits “7”, “6”, respectively, and the bodies in the third cycle and the fourth cycle are retrieved at the timing of raising the control terminal CA_clk (/WE) (rise edge), and the timing of falling the control terminal CA_clk (/WE) (fall edge).

While the case where the input of the command data Cmd (CMD) in the body set is instructed is described as an example of the header set, it is not limited to this. As illustrated in FIG. 12, the header set may instruct the input of the address data Add (ADD) in the body set. The header set may instruct the output of data (DOUT) in the body set, or the header set may instruct the input of data (DIN). The output of data (DOUT) includes, for example, an output of the status data Stt, the feature data Fd, or the ID. The input of data (DIN) includes, for example, an input of the feature data Fd. Header Rise Edge illustrated in FIG. 12 indicates the header in the first cycle, that is, a 2-bit first header input corresponding to the rise edge of the signal (clock signal) input to the control terminal CA_clk (/WE). Header Fall Edge indicates the header in the second cycle, that is, a 2-bit second header input corresponding to the fall edge of the signal (clock signal) input to the control terminal CA_clk (/WE).

### [Operations]

Next, operations of the memory die MD are described.

The memory die MD is configured to be able to perform the read operation. The read operation is an operation where the user data Dat is read from the memory cell array MCA by the sense amplifier module SAM and the read user data Dat is transferred to the latch circuit XDL. In the read operation, the user data Dat read from the memory cell array MCA is transferred to the latch circuit XDL via the bit line BL and the sense amplifier module SAM.

The memory die MD is configured to be able to perform the data-out operation. The data-out operation of the user data Dat is an operation where the user data Dat included in the latch circuit XDL is output to the controller die CD. In the data-out operation of the user data Dat, the user data Dat included in the latch circuit XDL is output to the controller die CD via the column decoder, the bus wiring DB, and the input/output control circuit I/O.

The memory die MD is configured to be able to perform the status read. The status read is an operation where the status data Stt included in the status register STR is output to the controller die CD. In the status read, the status data Stt included in the status register STR is output to the controller die CD via the logic circuit CTR.

The memory die MD is configured to be able to perform the get feature (a characteristic information output operation). The get feature is an operation where the feature data Fd included in the feature register FR (FIG. 5) is output to the controller die CD (FIG. 1). In the get feature, the feature data Fd included in the feature register FR is output to the controller die CD via the logic circuit CTR.

The memory die MD is configured to be able to perform the set feature. The set feature is an operation where the feature data Fd is input to the feature register FR (FIG. 5). In the set feature, the feature data Fd is input to the feature register FR from the controller die CD via the logic circuit CTR.

### [Set Feature in Normal Mode]

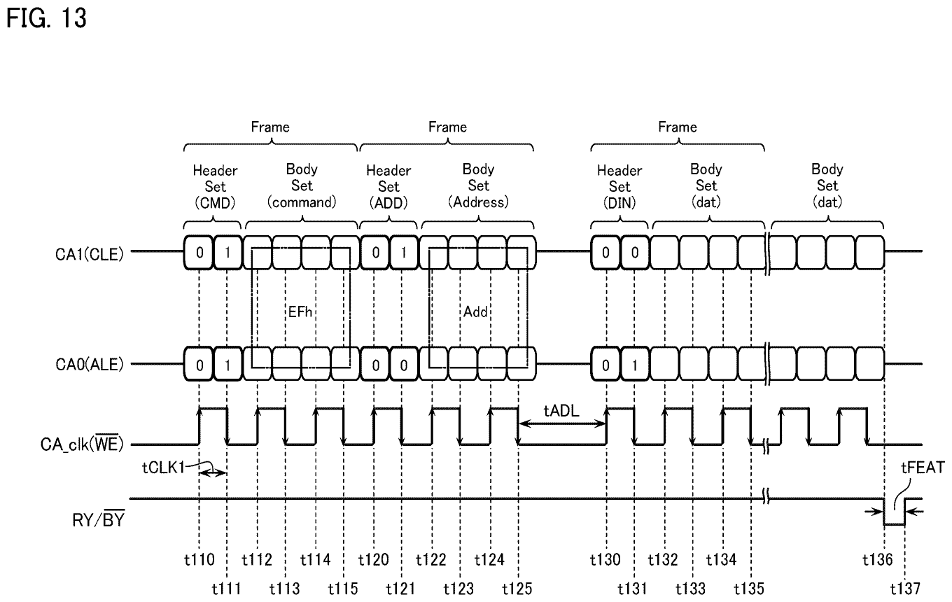

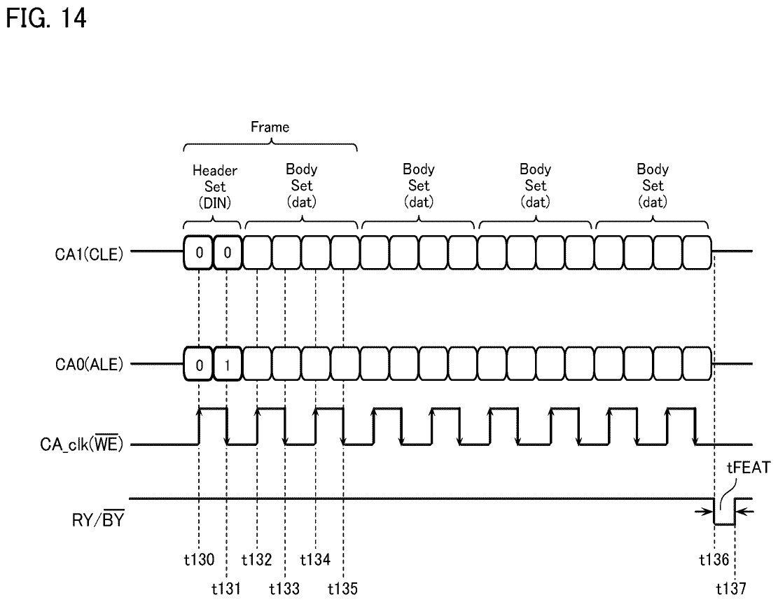

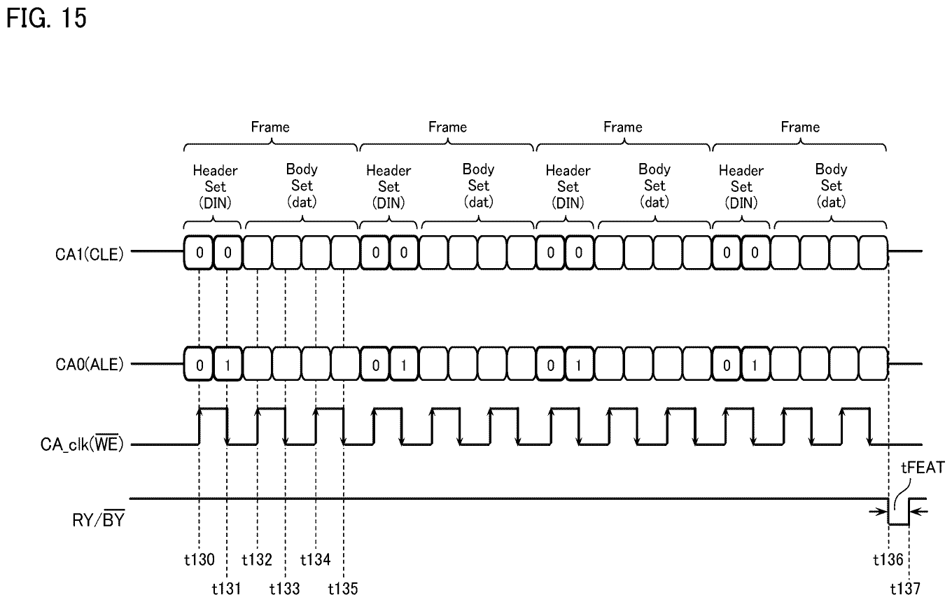

FIG. 13 to FIG. 15 are schematic waveform diagrams illustrating the input/output signal between the controller die CD and the memory die MD. FIG. 13 illustrates a schematic timing chart when the set feature is performed during the operation in the normal mode. FIG. 13 omits a part of the waveform. FIG. 14 illustrates an example of the omitted waveform. FIG. 15 illustrates another example of the omitted waveform.

Before timing t110 of FIG. 13, although not illustrated, the voltage of the control terminal /CE falls from “H” to “L”.

Subsequently, the controller die CD inputs the command set of the set feature (Set Feature) to the memory die MD at timing t110 to timing t135. That is, the controller die CD inputs the command data Cmd for instructing the set feature (Set Feature) to the memory die MD at timing t110 to timing t115, inputs the address data Add for specifying a feature address (for example, a part of the feature register FR) corresponding to a parameter and the like as a target of the set feature to the memory die MD at timing t120 to timing t125, and inputs the feature data Fd to be set to the feature address to the memory die MD at timing t130 to timing t135.

More specifically, at timing t110 to timing t111, the controller die CD inputs the header set constituted of the header in the first cycle indicating the bits “0”, “0” and the header in the second cycle indicating the bits “1”, “1” to the memory die MD via the control terminals CA1 (CLE), CA0 (ALE). This header set is, as illustrated in FIG. 12, the header set instructing to input the command data Cmd, and is input at (the timings of) the rise edge and the fall edge of the signal (clock signal) input to the control terminal CA_clk (/WE). In other words, at timing t110 to timing t111, in the frame corresponding to the command data Cdd constituting the command set of the set feature, a part corresponding to the header set (4-bit information) is input to the memory die MD corresponding to two toggles of the signal input to the control terminal CA_clk (/WE).

At timing t112 to timing t115, the controller die CD inputs command data EFh as the body set to the memory die MD via the control terminals CA1 (CLE), CA0 (ALE). The command data “EFh” is command data Cmd that instructs the set feature. When the command data EFh is input, the set feature is performed in every memory die MD in which “L” is input to the control terminal /CE. In other words, at timing t112 to timing t115, in the frame corresponding to the command data Cdd constituting the command set of the set feature, a part corresponding to the body set (8-bit information) is input to the memory die MD corresponding to four toggles of the signal input to the control terminal CA_clk (/WE). For example, an interval between the timing of the rise edge and the timing of the fall edge of the signal input to the control terminal CA_clk (/WE), and an interval between the timing of the fall edge and the timing of the rise edge of the signal input to the control terminal CA_clk (/WE) are a period tCLK1. That is, a toggle interval of the control terminal CA_clk (/WE) is the period tCLK1.

At timing t120 to timing t121, the controller die CD inputs the header set constituted of the header in the first cycle indicating the bits “0”, “0” and the header in the second cycle indicating the bits “1”, “0” to the memory die MD via the control terminals CA1 (CLE), CA0 (ALE). This header set is, as illustrated in FIG. 12, the header set instructing to input the address data Add, and is input at the rise edge and the fall edge of the signal (clock signal) input to the control terminal CA_clk (/WE). In other words, at timing t120 to timing t121, in the frame corresponding to the address data Add constituting the command set of the set feature, a part corresponding to the header set (4-bit information) is input to the memory die MD corresponding to two toggles of the signal input to the control terminal CA_clk (/WE).

At timing t122 to timing t125, the controller die CD inputs the address data Add as the body set to the memory die MD via the control terminals CA1 (CLE), CA0 (ALE). The address data Add is data for identifying a part (parameter and the like set in the set feature) to which the feature data Fd is input in the feature register FR. In other words, at timing t122 to timing t125, in the frame corresponding to the address data Add constituting the command set of the set feature, a part corresponding to the body set (8-bit information) is input to the memory die MD corresponding to four toggles of the signal input to the control terminal CA_clk (/WE).

At timing t130 to timing t131, the controller die CD inputs the header set constituted of the header in the first cycle indicating the bits “0”, “0” and the header in the second cycle indicating the bits “0”, “1” to the memory die MD via the control terminals CA1 (CLE), CA0 (ALE). This header set is, as illustrated in FIG. 12, the header set instructing to input the data, and is input at the rise edge and the fall edge of the signal (clock signal) input to the control terminal CA_clk (/WE). In other words, at timing t130 to timing t131, in the frame corresponding to the feature data Fd constituting the command set of the set feature, a part corresponding to the header set (4-bit information) is input to the memory die MD corresponding to two toggles of the signal input to the control terminal CA_clk (/WE).

The controller die CD maintains the signal (clock signal) input to the control terminal CA_clk (/WE) at “L” during a period tADL from timing t125 to timing t130. In other words, after the input of the frame corresponding to the address data Add constituting the command set of the set feature to the memory die MD, the controller die CD suspends the input of the frame corresponding to the feature data Fd to the memory die MD for at least the period tADL. In this period, the signal input to the control terminal CA_clk (/WE) is not toggled. The period tADL is set, for example, to ensure the appropriate input of the feature data Fd input by the memory die MD to the part specified in the feature register FR after the input of the command data Cmd and the address data Add constituting the command set of the set feature to the memory die MD.

At timing t132 to timing t135, the controller die CD inputs the feature data Fd as data to memory die MD. This feature data Fd includes information indicative of an operation parameter and the like. While the drawing illustrates an example in which the data of 8-bit×4-cycle constituting the feature data Fd is input at timing t132 to timing t135, the number of cycles may be smaller or larger than four.

At the input of the feature data Fd, for example, as illustrated in FIG. 14, the header set instructing to input the data may be input once, and then a plurality of body sets constituting the feature data Fd may be sequentially input. That is, the input of the header set may be omitted until the input of the feature data Fd is completed. For example, as illustrated in FIG. 15, a frame including both the header set instructing to input the data and the body set constituting the feature data Fd may be input multiple times.

After timing t136, the set feature is started, and the voltage of the terminal RY//BY falls from “H” to “L”.

At timing t137, the set feature is completed, and the voltage of the terminal RY//BY rises from “L” to “H”. In a period tFEAT from when the voltage of the terminal RY//BY falls once to when the voltage of the terminal RY//BY rises again, the set feature in which the feature data Fd is input to the part specified in the feature register FR is performed.

### [Get Feature in Normal Mode]

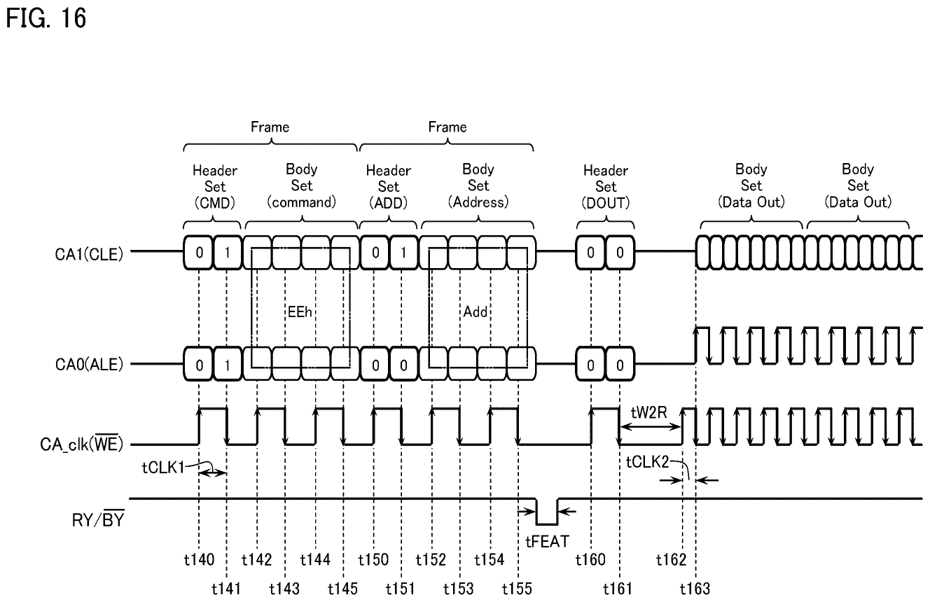

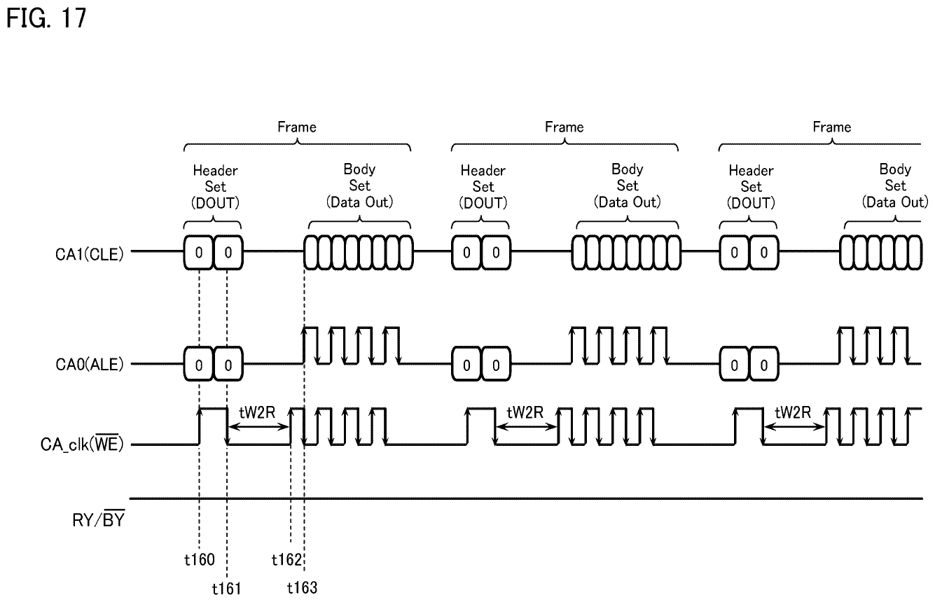

FIG. 16 and FIG. 17 are schematic waveform diagrams illustrating the input/output signal between the controller die CD and the memory die MD. FIG. 16 illustrates a schematic timing chart when the get feature is executed during the operation in the normal mode. FIG. 17 illustrates another example of a part of the waveform illustrated in FIG. 16.

Before timing t140 of FIG. 16, although not illustrated, the voltage of the control terminal /CE falls from “H” to “L”.

In the example of FIG. 16, at timing t140 to timing t141, the controller die CD inputs the header set constituted of the header in the first cycle indicating the bits “0”, “0” and the header in the second cycle indicating the bits “1”, “1” to the memory die MD via the control terminals CA1 (CLE), CA0 (ALE). This header set is, as illustrated in FIG. 12, the header set instructing to input the command data Cmd, and is input at the rise edge and the fall edge of the signal (clock signal) input to the control terminal CA_clk (/WE).

At timing t142 to timing t145, the controller die CD inputs command data EEh as the body set to the memory die MD via the control terminals CA1 (CLE), CA0 (ALE). The command data “EEh” is command data Cmd that instructs the get feature. When the command data EEh is input, the get feature is performed in every memory die MD in which “L” is input to the control terminal /CE.

At timing t150 to timing t151, the controller die CD inputs the header set constituted of the header in the first cycle indicating the bits “0”, “0” and the header in the second cycle indicating the bits “1”, “0” to the memory die MD via the control terminals CA1 (CLE), CA0 (ALE). This header set is, as illustrated in FIG. 12, the header set instructing to input the address data Add, and is input at the rise edge and the fall edge of the signal (clock signal) input to the control terminal CA_clk (/WE).

At timing t152 to timing t155, the controller die CD inputs the address data Add as the body set to the memory die MD via the control terminals CA1 (CLE), CA0 (ALE). The address data Add is data for identifying a part storing the feature data Fd intended to be output in the feature register FR.

After the elapse of a predetermined time from timing t155, in the period tFEAT from when the voltage of the terminal RY//BY falls once to when the voltage of the terminal RY//BY rises again, for example, the control parameter or the like of the memory die MD is read out as the feature data Fd latched at the part specified in the feature register FR.

At timing t160 to timing t161, the controller die CD inputs the header set constituted of the header in the first cycle indicating the bits “0”, “0” and the header in the second cycle indicating the bits “0”, “0” to the memory die MD via the control terminals CA1 (CLE), CA0 (ALE). This header set is, as illustrated in FIG. 12, the header set instructing to output the data, and is input at the rise edge and the fall edge of the signal (clock signal) input to the control terminal CA_clk (/WE).

According to the input of the header set, after a predetermined standby time (after a period tW2R), the controller die CD switches (toggles) the input signal of the control terminal CA_clk (/WE) to specify a timing of outputting the data.

More specifically, at timing t160, the controller die CD switches the input signal of the control terminal CA_clk (/WE) from “L” to “H”. At timing t161, the controller die CD switches the input signal of the control terminal CA_clk (/WE) from “H” to “L”, and then, repeats the switching (toggle). Thus, the data output operation is started, and the feature data Fd acquired by the get feature is output at the rise edge and the fall edge of the output signal of the control terminal CA0 (ALE) via the control terminal CA1 (CLE).

For example, an interval between the timing of the rise edge and the timing of the fall edge of the signal input to the control terminal CA_clk (/WE), and an interval between the timing of the fall edge and the timing of the rise edge of the signal output from the control terminal CA0 (ALE) are a period tCLK2. That is, a toggle interval of the control terminal CA_clk (/WE) is the period tCLK2. The signal of the control terminal CA0 (ALE) is a signal having the same frequency as the signal (clock signal) input to the control terminal CA_clk (/WE), and is referred to as a strobe signal in some cases. The strobe signal indicates the switch of the bit of the status data Stt. That is, at the rise edge and the fall edge of the signal of the control terminal CA0 (ALE), 1-bit data is output to the control terminal CA1 (CLE). In other words, every time when 1-bit data is output to the control terminal CA1 (CLE), the signal (strobe signal) of the control terminal CA0 (ALE) rises or falls. Therefore, even when “0” is sequentially output or “1” is sequentially output from the control terminal CA1 (CLE), the break of the data can be determined.

At the output of the feature data Fd, for example, as illustrated in FIG. 16, the header set instructing to output the data may be input once, and then a plurality of body sets constituting the feature data Fd may be sequentially output. That is, the input of the header set may be omitted until the output of the feature data Fd is completed. For example, as illustrated in FIG. 17, the body set constituting the feature data Fd may be output once every time when the header set instructing to output the data is input once.

### [Status Read in Normal Mode]

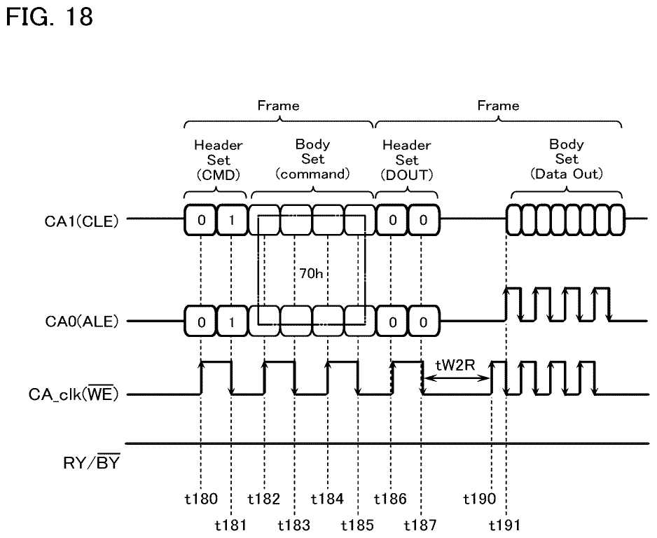

FIG. 18 is a schematic waveform diagram illustrating the input/output signal between the controller die CD and the memory die MD. FIG. 18 illustrates a schematic timing chart when the status read is performed during the operation in the normal mode.

Before timing t180 of FIG. 18, although not illustrated, the voltage of the control terminal /CE falls from “H” to “L”.

In the example of FIG. 18, at timing t180 to timing t181, the controller die CD inputs the header set constituted of the header in the first cycle indicating the bits “0”, “0” and the header in the second cycle indicating the bits “1”, “1” to the memory die MD via the control terminals CA1 (CLE), CA0 (ALE). This header set is, as illustrated in FIG. 12, the header set instructing to input the command data Cmd, and is input at the rise edge and the fall edge of the signal input to the control terminal CA_clk (/WE).

At timing t182 to timing t185, the controller die CD inputs command data 70h as the body set to the memory die MD via the control terminals CA1 (CLE), CA0 (ALE). The command data “70h” is command data Cmd that instructs the status read. When the command data 70h is input, for example, the status read is performed in every memory die MD in which the command set is most recently input.

At timing t186 to timing t187, the controller die CD inputs the header set constituted of the header in the first cycle indicating the bits “0”, “0” and the header in the second cycle indicating the bits “0”, “0” to the memory die MD via the control terminals CA1 (CLE), CA0 (ALE). This header set is, as illustrated in FIG. 12, the header set instructing to output the data, and is input at the rise edge and the fall edge of the signal input to the control terminal CA_clk (/WE).

According to the input of the header set, after a predetermined standby time (after a period tW2R), the controller die CD switches (toggles) the input signal of the control terminal CA_clk (/WE) to specify a timing of outputting the data. Thus, the data output operation is started, and the status data Stt acquired by the status read is output at the rise edge and the fall edge of the output signal (strobe signal) of the control terminal CA0 (ALE) via the control terminal CA1 (CLE). The output signal of the control terminal CA0 (ALE) is a strobe signal having the same frequency as the signal (clock signal) input to the control terminal CA_clk (/WE). At the rise edge and the fall edge of the signal of the control terminal CA0 (ALE), 1-bit data is output to the control terminal CA1 (CLE). In other words, every time when 1-bit data is output to the control terminal CA1 (CLE), the signal of the control terminal CA0 (ALE) rises or falls. Therefore, even when “0” is sequentially output or “1” is sequentially output from the control terminal CA1 (CLE), the break of the data can be determined.

### [Roles of Respective Terminals in Output Mode of Working Example]

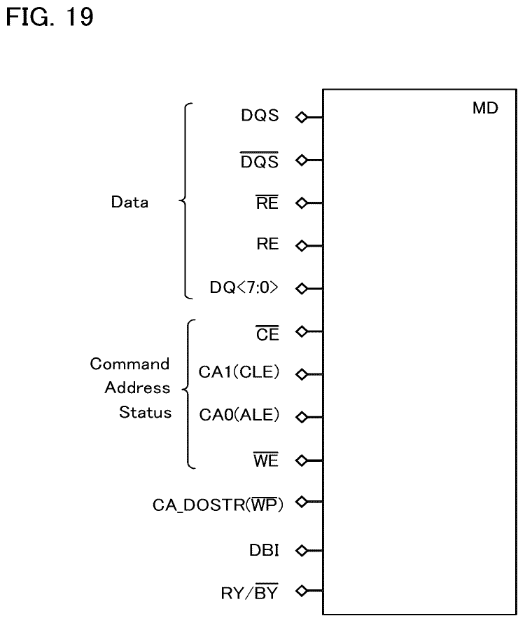

FIG. 19 is a schematic view for describing roles of signal input/output terminals and control terminals of the memory die MD in a working example.

The memory die MD according to the working example uses the control terminal /WE for inputting the clock signal, and uses the control terminals CA1 (CLE), CA0 (ALE) for inputting the command data Cmd and the address data Add and outputting the data, such as status data Stt. The memory die MD according to the working example sets (assigns) the control terminal /WP to the control terminal CA_DOSTR (/WP) used for outputting the strobe signal. In the memory die MD according to the working example, the terminal DBI and the terminal RY//BY are not used for outputting the strobe signal.

### [Exemplary Header Set Input in Output Mode of Working Example]

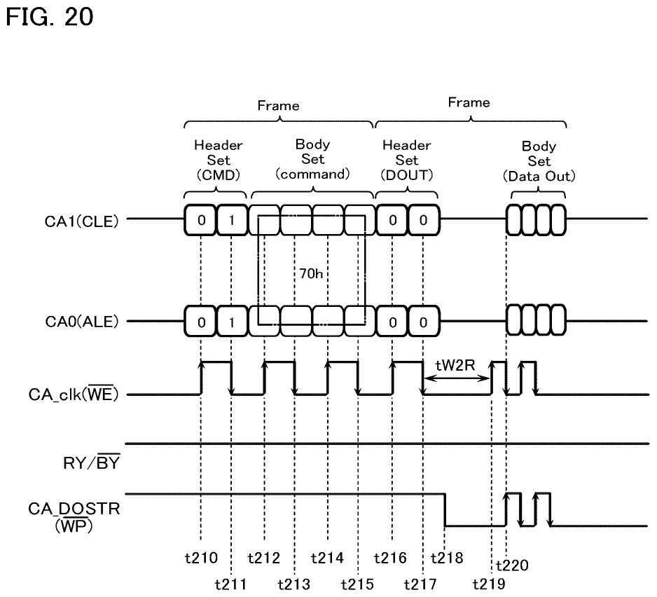

FIG. 20 is a schematic waveform diagram illustrating the input/output signal between the controller die CD and the memory die MD in the working example. FIG. 20 illustrates a schematic timing chart when the status read is performed during the operation in the output mode of the memory die MD in the working example.

Before timing t210 of FIG. 20, although not illustrated, the voltage of the control terminal /CE falls from “H” to “L”. Before timing t210, the memory die MD sets (assigns) the control terminal /WP to the control terminal CA_DOSTR (/WP) used for outputting the strobe signal.

In the example of FIG. 20, at timing t210 to timing t211, the controller die CD inputs the header set constituted of the header in the first cycle indicating the bits “0”, “0” and the header in the second cycle indicating the bits “1”, “1” to the memory die MD via the control terminals CA1 (CLE), CA0 (ALE). This header set is, as illustrated in FIG. 12, the header set instructing to input the command data Cmd, and is input at the rise edge and the fall edge of the signal input to the control terminal CA_clk (/WE).

At timing t212 to timing t215, the controller die CD inputs the command data 70h as the body set to the memory die MD via the control terminals CA1 (CLE), CA0 (ALE). The command data “70h” is command data Cmd that instructs the status read.

At timing t216 to timing t217, the controller die CD inputs the header set constituted of the header in the first cycle indicating the bits “0”, “0” and the header in the second cycle indicating the bits “0”, “0” to the memory die MD via the control terminals CA1 (CLE), CA0 (ALE). This header set is, as illustrated in FIG. 12, the header set instructing to output the data, and is input at the rise edge and the fall edge of the signal input to the control terminal CA_clk (/WE).

According to the input of the header set, after a predetermined standby time (after a period tW2R), the controller die CD switches (toggles) the input signal of the control terminal CA_clk (/WE) to specify a timing of outputting the data.

More specifically, at timing t219, the controller die CD switches the input signal of the control terminal CA_clk (/WE) from “L” to “H”. At timing t220, the controller die CD switches the input signal of the control terminal CA_clk (/WE) from “H” to “L”, and then, repeats the switching (toggle).

Thus, the data output operation is started, and the status data Stt acquired by the status read is output via the control terminal CA1 (CLE) and the control terminal CA0 (ALE). At the timing of switching the data of the control terminals CA1 (CLE), CA0 (ALE), the output signal of the control terminal CA_DOSTR (/WP) is switched from “L” to “H” or switched from “H” to “L”. The output signal of the control terminal CA_DOSTR (/WP) is a strobe signal having the same frequency as the signal (clock signal) input to the control terminal CA_clk (/WE). At the rise edge and the fall edge of the input signal (strobe signal) of the control terminal CA_DOSTR (/WP), 1-bit data is output at the control terminal CA1 (CLE), and 1-bit data is output at the control terminal CA0 (ALE), thus 2-bit data in total is output.

### [Get Feature in Output Mode of Working Example]

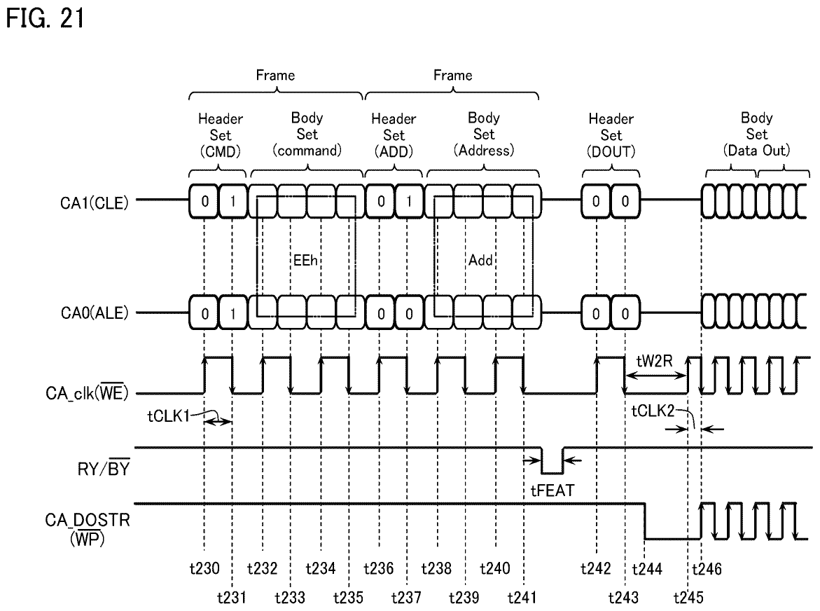

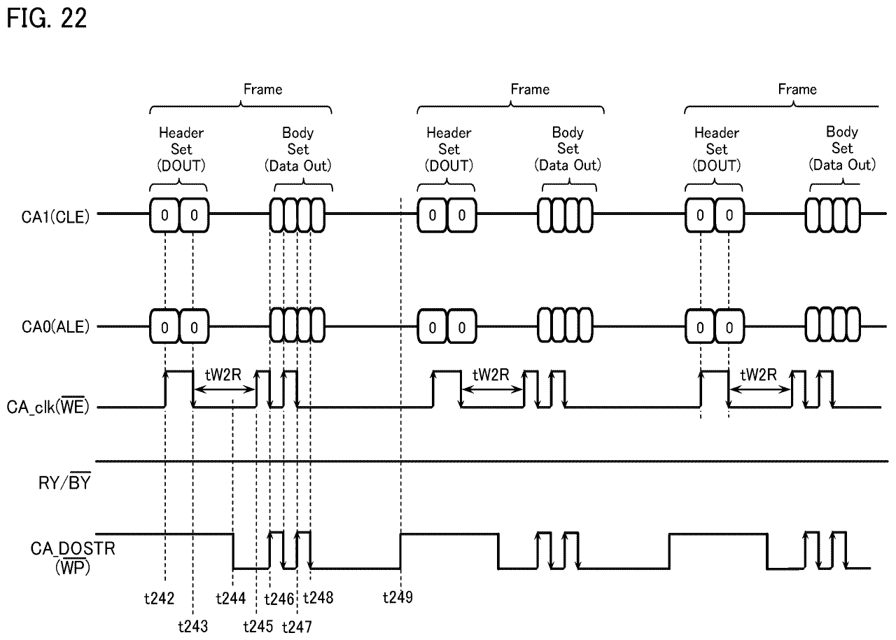

FIG. 21 and FIG. 22 are schematic waveform diagrams illustrating the input/output signal between the controller die CD and the memory die MD in the working example. FIG. 21 illustrates a schematic timing chart when the get feature is performed during the operation in the output mode of the working example. FIG. 22 illustrates another example of a part of the waveform illustrated in FIG. 21.

Before timing t230 of FIG. 21, although not illustrated, the voltage of the control terminal /CE falls from “H” to “L”. Before timing t230, the memory die MD sets (assigns) the control terminal /WP to the control terminal CA_DOSTR (/WP) used for outputting the strobe signal.

In the example of FIG. 21, at timing t230 to timing t231, the controller die CD inputs the header set constituted of the header in the first cycle indicating the bits “0”, “0” and the header in the second cycle indicating the bits “1”, “1” to the memory die MD via the control terminals CA1 (CLE), CA0 (ALE). This header set is, as illustrated in FIG. 12, the header set instructing to input the command data Cmd, and is input at the rise edge and the fall edge of the signal (clock signal) input to the control terminal CA_clk (/WE).

At timing t232 to timing t235, the controller die CD inputs the command data EEh as the body set to the memory die MD via the control terminals CA1 (CLE), CA0 (ALE). The command data “EEh” is command data Cmd that instructs the get feature. When the command data EEh is input, the get feature is performed in every memory die MD in which “L” is input to the control terminal /CE.

At timing t236 to timing t237, the controller die CD inputs the header set constituted of the header in the first cycle indicating the bits “0”, “0” and the header in the second cycle indicating the bits “1”, “0” to the memory die MD via the control terminals CA1 (CLE), CA0 (ALE). This header set is, as illustrated in FIG. 12, the header set instructing to input the address data Add, and is input at the rise edge and the fall edge of the signal (clock signal) input to the control terminal CA_clk (/WE).

At timing t238 to timing t241, the controller die CD inputs the address data Add as the body set to the memory die MD via the control terminals CA1 (CLE), CA0 (ALE). The address data Add is data for identifying a part storing the feature data Fd intended to be output in the feature register FR.

After the elapse of a predetermined time from timing t241, in the period tFEAT from when the voltage of the terminal RY//BY falls once to when the voltage of the terminal RY//BY rises again, for example, the control parameter or the like of the memory die MD is read out as the feature data Fd latched at the part specified in the feature register FR.

At timing t242 to timing t243, the controller die CD inputs the 4-bit header set constituted of the header in the first cycle indicating the bits “0”, “0” and the header in the second cycle indicating the bits “0”, “0” to the memory die MD via the control terminals CA1 (CLE), CA0 (ALE). This header set is, as illustrated in FIG. 12, the header set instructing to output the data, and is input at the rise edge and the fall edge of the signal (clock signal) input to the control terminal CA_clk (/WE).

According to the input of the header set, after a predetermined standby time (after a period tW2R), the controller die CD switches (toggles) the input signal of the control terminal CA_clk (/WE) to specify a timing of outputting the data.

More specifically, at timing t245, the controller die CD switches the input signal of the control terminal CA_clk (/WE) from “L” to “H”. At timing t246, the controller die CD switches the input signal of the control terminal CA_clk (/WE) from “H” to “L”, and then, repeats the switching (toggle). Thus, the data output operation is started, and the feature data Fd acquired by the get feature is output via the control terminals CA1 (CLE), CA0 (ALE). At the timing of switching the data of the control terminals CA1 (CLE), CA0 (ALE), the output signal of the control terminal CA_DOSTR (/WP) is switched from “L” to “H” or switched from “H” to “L”.

For example, an interval between the timing of the rise edge and the timing of the fall edge of the signal input to the control terminal CA_clk (/WE), and an interval between the timing of the fall edge and the timing of the rise edge of the signal output from the control terminal CA_DOSTR (/WP) are a period tCLK2. That is, a toggle interval of the control terminal CA_clk (/WE) is the period tCLK2. A toggle interval of the control terminal CA_DOSTR (/WP) is also the period tCLK2. The signal of the control terminal CA_DOSTR (/WP) is a strobe signal having the same frequency as the signal (clock signal) input to the control terminal CA_clk (/WE), and at the rise edge and the fall edge of the signal of the control terminal CA_DOSTR (/WP), 2-bit data is output from the control terminals CA1 (CLE), CA0 (ALE).

At the output of the feature data Fd, for example, as illustrated in FIG. 21, the header set instructing to output the data may be input once, and then (after timing t242 to timing t243), a plurality of body sets constituting the feature data Fd may be sequentially output (sequentially after timing t246). That is, the input of the header set may be omitted until the output of the feature data Fd is completed.

For example, as illustrated in FIG. 22, the body set constituting the feature data Fd may be output once every time when the header set instructing to output the data is input once. Here, for example, the body set constituting the feature data Fd is an 8-bit body set. In the example illustrated in FIG. 22, at timing t246 to timing t248, the memory die MD outputs the 8-bit body set to the controller die CD at the rise edge and the fall edge of the signal of the control terminal CA_DOSTR (/WP) by two bits in four cycles via the control terminals CA1 (CLE), CA0 (ALE).

Then, after timing t248, the rise of the signal input to the control terminal CA_clk (/WE) is delayed for a predetermined time to ensure a time for inputting the header set that instructs to output the next data. Since the following operation is similar to the operation at timing t242 to timing t249, the explanation is omitted.

While the case the control terminal /WP is set (assigned) to the control terminal CA_DOSTR (/WP) used for outputting the strobe signal is described, the memory die MD according to the working example is not limited to this. In the memory system according to the embodiment, the terminal DBI or the terminal RY//BY may be set (assigned) to the control terminal CA_DOSTR (DBI) or the control terminal CA_DOSTR (RY//BY) used for outputting the strobe signal.

These settings can be made, for example, by execution of the set feature, the setting using a ROM parameter of the ROM disposed in the memory system (for example, in the memory cell array MCA), or an external terminal (for example, one of the pad electrodes P described with reference to FIG. 3A and FIG. 3B) provided to the memory die MD.

### [Effects]

As described above, during the operation in the normal mode of the memory die MD, for example, as illustrated in FIG. 16 and FIGS. 17, 1-bit data is output from the control terminal CA1 (CLE) at the rise edge and the fall edge of the strobe signal input to the control terminal CA0 (ALE). Therefore, during the operation in the normal mode, the data transfer performance from the memory die MD to the controller die CD is low in the memory die MD.

In view of this, the semiconductor memory device according to the embodiment is operable also in the output mode of the working example in addition to the normal mode. For example, in order to switch the memory die MD from the normal mode to the output mode of the working example, the controller die CD can assign (set), for example, the control terminal /WP, the terminal DBI, or the terminal RY//BY of the memory die MD to the control terminal CA_DOSTR (/WP) to which the strobe signal is input. This allows, in the output mode of the working example, outputting 1-bit data at the control terminal CA1 (CLE) and 1-bit data at the control terminal CA0 (ALE), thus 2-bit data in total at the rise edge and the fall edge of the output signal (strobe signal) of the control terminal CA_DOSTR (/WP). Accordingly, the memory die MD can output the data by two bits during the operation in the output mode of the working example, thereby allowing the improvement of the data transfer performance from the memory die MD to the controller die CD.

### SECOND EMBODIMENT

In the first embodiment, the example in which one of the control terminal /WP, the terminal DBI, and the terminal RY//BY is assigned to the control terminal CA_DOSTR to input the strobe signal is described. Further, the example in which the 2-bit data is output from the control terminals CA1 (CLE), CA0 (ALE) at, for example, the rise edge and the fall edge of the strobe signal output from the control terminal CA_DOSTR, such as a control terminal CA_DOSTR (/WP) is described. However, the memory system 10 may be configured be able to, for example, use at least one of the terminals, such as a control terminal /WP, a terminal DBI, and a terminal RY//BY, which are not assigned to the control terminal CA_DOSTR, for inputting and outputting the data in addition to the control terminals CA1 (CLE), CA0 (ALE). Such an example is described as a second embodiment below.

A memory system according to the second embodiment is basically configured similarly to the memory system 10 according to the first embodiment. In the following description, the same reference numerals are attached to parts similar to those in the first embodiment, and the explanation is omitted.

### [Roles of Respective Terminals in Output Mode of Second Embodiment]

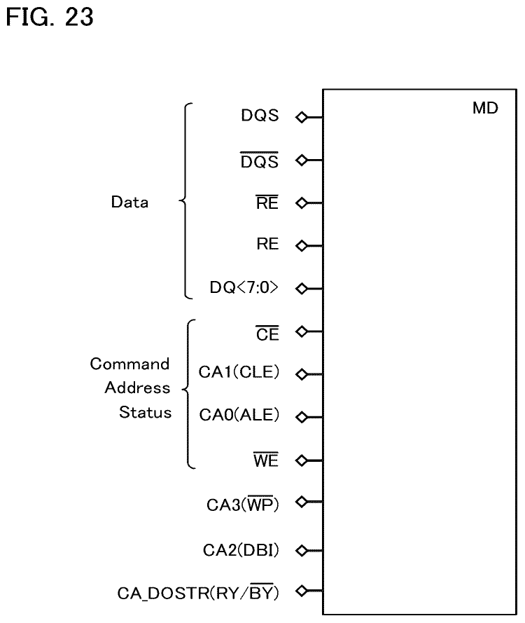

FIG. 23 is a schematic view for describing roles of the signal input/output terminals and the control terminals of the memory die MD in the second embodiment.

In the memory die MD according to the second embodiment, for example, as illustrated in FIG. 23, the control terminal /WE is used for inputting the clock signal, the control terminals CA1 (CLE), CA0 (ALE) are used for inputting the command data Cmd and the address data Add and outputting the data, such as status data Stt. In the example of FIG. 23, one of the control terminal /WP, the terminal DBI, and the terminal RY//BY is assigned to the control terminal CA_DOSTR used for outputting the strobe signal, and the other two of the control terminal /WP, the terminal DBI, and the terminal RY//BY are assigned to terminals CA3, CA2 used for inputting the command data Cmd and the address data Add and inputting and outputting the data, such as status data Stt.

In the example of FIG. 23, for example, the terminal RY//BY is set (assigned) to the control terminal CA_DOSTR (RY//BY) used for outputting the strobe signal, the terminal DBI is set (assigned) to the control terminal CA2 (DBI) used for inputting and outputting the data, and the control terminal /WP is set (assigned) to the control terminal CA3 (/WP) used for inputting and outputting the data.

These settings can be made similarly to the first embodiment, for example, by execution of the set feature, the setting using a ROM parameter of the ROM disposed in the memory system (for example, in the memory cell array MCA), or an external terminal (for example, one of the pad electrodes P described with reference to FIG. 3A and FIG. 3B) provided to the memory die MD.

With this setting, the memory die MD can output the 4-bit data at the rise edge and the fall edge of the strobe signal, which is output from the control terminal CA_DOSTR (RY//BY), from the control terminals CA1 (CLE), CA0 (ALE), CA2 (DBI), CA3 (/WP).

### [Exemplary Header Set Input in Output Mode of Second Embodiment]

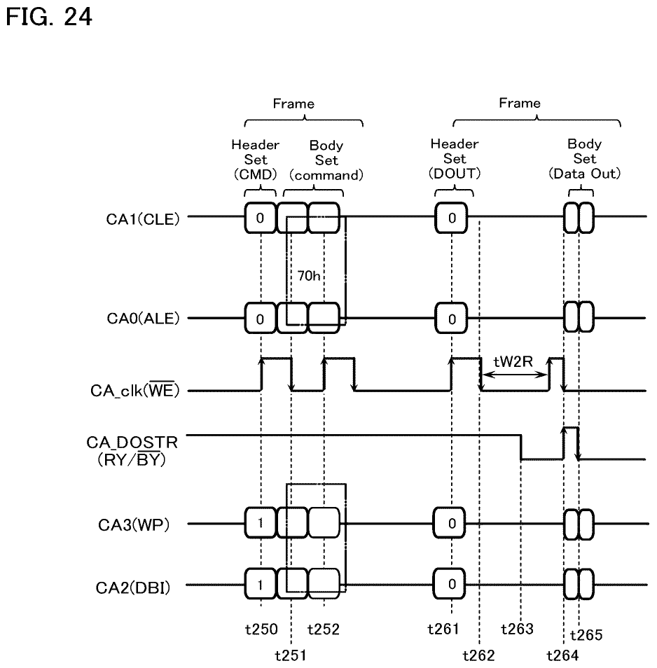

FIG. 24 is a schematic waveform diagram illustrating the input/output signal between the controller die CD and the memory die MD in the second embodiment. FIG. 24 illustrates a schematic timing chart when the status read is performed during the operation in the output mode of the memory die MD in the second embodiment.

Before timing t250 of FIG. 24, although not illustrated, the voltage of the control terminal /CE falls from “H” to “L”. Before timing t250, the memory die MD sets the terminal RY//BY to the control terminal CA_DOSTR (RY//BY) used for outputting the strobe signal, sets the terminal DBI to the control terminal CA2 (DBI) used for inputting and outputting the data, and sets the control terminal /WP to the control terminal CA3 (/WP) used for inputting and outputting the data.

In the example of FIG. 24, at timing t250, the controller die CD inputs the header (header set) in the first cycle indicating the bits “0”, “0”, “1”, “1” to the memory die MD via the control terminals CA1 (CLE), CA0 (ALE), CA2 (DBI), CA3 (/WP). This header set is, as illustrated in FIG. 12, the header set instructing to input the command data Cmd, and is input at the rise edge (or the fall edge) of the signal (clock signal) input to the control terminal CA_clk (/WE).

At timing t251 to timing t252, the controller die CD inputs the command data 70h as the body set to the memory die MD via the control terminals CA1 (CLE), CA0 (ALE), CA2 (DBI), CA3 (/WP). The command data “70h” is command data Cmd that instructs the status read.

At timing t261, the controller die CD inputs the header (header set) in the first cycle indicating the bits “0”, “0”, “0”, “0” to the memory die MD via the control terminals CA1 (CLE), CA0 (ALE), CA2 (DBI), CA3 (/WP). This header set is, as illustrated in FIG. 12, the header set instructing to output the data, and is input at the rise edge (or the fall edge) of the signal (clock signal) input to the control terminal CA_clk (/WE).

After the input at the fall edge of the signal input to the control terminal CA_clk (/WE), after the elapse of a predetermined standby time (after the period tW2R), the controller die CD switches (toggles) the input signal of the control terminal CA_clk (/WE) to specify a timing of outputting the data.

More specifically, after the period tW2R, the controller die CD switches the input signal of the control terminal CA_clk (/WE) from “L” to “H”. At timing t264, the controller die CD switches the input signal of the control terminal CA_clk (/WE) from “H” to “L”, and then, repeats the switching (toggle). Thus, the data output operation is started, and the status data Stt acquired by the status read is output via the control terminals CA1 (CLE), CA0 (ALE), CA2 (DBI), CA3 (/WP). At the timing of switching the data of the control terminals CA1 (CLE), CA0 (ALE), CA2 (DBI), CA3 (/WP), the output signal of the control terminal CA_DOSTR (RY//BY) is switched from “L” to “H” or switched from “H” to “L”.

The input signal of the control terminal CA_DOSTR (RY//BY) is a strobe signal having the same frequency as the signal (clock signal) input to the control terminal CA_clk (/WE). At the rise edge and the fall edge of the input signal (strobe signal) of the control terminal CA_DOSTR (RY//BY), 4-bit data is output from the control terminals CA1 (CLE), CA0 (ALE), CA2 (DBI), CA3 (/WP).

Specifically, at timing t263, the voltage of the control terminal CA_DOSTR (RY//BY) falls from “H” to “L”.

At timing t264 to t265, the memory die MD outputs the data of the 8-bit body set to the controller die CD by four bits in two cycles at the rise edge and the fall edge of the input signal (strobe signal) of the control terminal CA_DOSTR (RY//BY) via the control terminals CA1 (CLE), CA0 (ALE), CA2 (DBI), CA3 (/WP).

Accordingly, during the operation in the output mode of the second embodiment, the memory die MD can output the data by four bits, and this allows further improvement of the data read performance to the controller die CD and the data transfer performance from the memory die MD.

### [Others]

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

While it is described that the memory die MD inputs and outputs the data by four bits in the second embodiment, the data may be input and output by three bits. In this case, for example, the terminal RY//BY may be set to the control terminal CA_DOSTR (RY//BY) used for outputting the strobe signal, and the control terminal /WP may be set to the control terminal CA3 (/WP) used for inputting and outputting the data.

What is claimed is:

1. A semiconductor memory device comprising:
a first pin usable for inputting and outputting data;
a second pin usable for inputting and outputting data;
a third pin to which a clock signal is input from a controller;
a fourth pin; and
a memory cell array including a string in which a plurality of memory cell transistors are connected in series, wherein
the semiconductor memory device is configured to be able to perform:
a first data output method for outputting data from the second pin and outputting a strobe signal from the first pin in synchronization with the data according to the clock signal input to the third pin; and
a second data output method for outputting data from the first pin and the second pin and outputting the strobe signal from the fourth pin in synchronization with the data according to the clock signal input to the third pin.

2. The semiconductor memory device according to claim 1, wherein
data output from the first pin or from the first pin and the second pin is status data, feature data, or ID.

3. The semiconductor memory device according to claim 1, further comprising:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input, wherein
one of the fifth pin, the sixth pin, and the seventh pin is usable as the fourth pin.

4. The semiconductor memory device according to claim 1, wherein
the first data output method and the second data output method are able to be switched by performing a set feature, setting a ROM parameter, or using an external terminal.

5. The semiconductor memory device according to claim 1, further comprising
an eighth pin, wherein
data is allowed to be output also from the eighth pin in addition to the first pin and the second pin in the second data output method.

6. The semiconductor memory device according to claim 5, further comprising:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input, wherein
one of the fifth pin, the sixth pin, and the seventh pin is usable as the fourth pin, and
another one of the fifth pin, the sixth pin, and the seventh pin is usable as the eighth pin.

7. The semiconductor memory device according to claim 6, wherein
the one of the fifth pin, the sixth pin, and the seventh pin is settable to the fourth pin, and the another one of the fifth pin, the sixth pin, and the seventh pin is settable to the eighth pin by performing a set feature, setting a ROM parameter, or using an external terminal.

8. The semiconductor memory device according to claim 5, wherein
the semiconductor memory device is configured to be able to further perform:
a first data input method for inputting data from the first pin and the second pin according to the clock signal input to the third pin; and
a second data input method for inputting data from the first pin, the second pin, and the eighth pin according to the clock signal input to the third pin.

9. The semiconductor memory device according to claim 1, further comprising:
an eighth pin; and
a ninth pin, wherein
data is allowed to be output also from the eighth pin and the ninth pin in addition to the first pin and the second pin in the second data output method.

10. The semiconductor memory device according to claim 9, further comprising:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input, wherein
one of the fifth pin, the sixth pin, and the seventh pin is usable as the fourth pin, and
the other two of the fifth pin, the sixth pin, and the seventh pin are usable as the eighth pin and the ninth pin.

11. The semiconductor memory device according to claim 10, wherein
the one of the fifth pin, the sixth pin, and the seventh pin is settable to the fourth pin, and the other two of the fifth pin, the sixth pin, and the seventh pin are settable to the eighth pin and the ninth pin by performing a set feature, setting a ROM parameter, or using an external terminal.

12. The semiconductor memory device according to claim 9, wherein
the semiconductor memory device is configured to be able to further perform:
a first data input method for inputting data from the first pin and the second pin according to the clock signal input to the third pin; and
a second data input method for inputting data from the first pin, the second pin, the eighth pin, and the ninth pin according to the clock signal input to the third pin.

13. A controller that controls a semiconductor memory device, wherein
the semiconductor memory device includes:
a first pin usable for inputting and outputting data;
a second pin usable for inputting and outputting data;
a third pin to which a clock signal is input from the controller;
a fourth pin; and
a memory cell array including a string in which a plurality of memory cell transistors are connected in series, and
the controller is configured to be able to cause the semiconductor memory device to perform:
a first data output method for outputting data from the second pin and outputting a strobe signal from the first pin in synchronization with the data according to the clock signal input to the third pin; and
a second data output method for outputting data from the first pin and the second pin and outputting the strobe signal from the fourth pin in synchronization with the data according to the clock signal input to the third pin.

14. The controller according to claim 13, wherein
when data is output from the semiconductor memory device by the second data output method, data is retrievable from the first pin and the second pin at timings of a rise edge and a fall edge of the strobe signal.

15. The controller according to claim 13, wherein
data output from the first pin or from the first pin and the second pin is status data, feature data, or ID.

16. The controller according to claim 13, wherein
the semiconductor memory device includes:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input, and
one of the fifth pin, the sixth pin, and the seventh pin is usable as the fourth pin.

17. The controller according to claim 13, wherein
the first data output method and the second data output method are switched by performing a set feature, setting a ROM parameter, or using an external terminal.

18. The controller according to claim 13, wherein
the semiconductor memory device further includes an eighth pin, and
data is allowed to be output also from the eighth pin in addition to the first pin and the second pin in the second data output method.

19. The controller according to claim 18, wherein
when data is output from the semiconductor memory device by the second data output method, data is retrievable from the first pin, the second pin, and the eighth pin at timings of a rise edge and a fall edge of the strobe signal.

20. The controller according to claim 18, wherein
the semiconductor memory device includes:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input,
one of the fifth pin, the sixth pin, and the seventh pin is usable as the fourth pin, and
another one of the fifth pin, the sixth pin, and the seventh pin is usable as the eighth pin.

21. The controller according to claim 20, wherein
the one of the fifth pin, the sixth pin, and the seventh pin is settable to the fourth pin, and the another one of the fifth pin, the sixth pin, and the seventh pin is settable to the eighth pin by performing a set feature, setting a ROM parameter, or using an external terminal.

22. The controller according to claim 18, wherein
the controller is configured to be able to cause the semiconductor memory device to further perform:
a first data input method for inputting data from the first pin and the second pin according to the clock signal input to the third pin; and
a second data input method for inputting data from the first pin, the second pin, and the eighth pin according to the clock signal input to the third pin.

23. The controller according to claim 13, wherein
the semiconductor memory device further includes:
an eighth pin; and
a ninth pin, and
data is allowed to be output also from the eighth pin and the ninth pin in addition to the first pin and the second pin in the second data output method.

24. The controller according to claim 23, wherein
when data is output from the semiconductor memory device by the second data output method, data is retrievable from the first pin, the second pin, the eighth pin, and the ninth pin at timings of a rise edge and a fall edge of the strobe signal.

25. The controller according to claim 23, wherein
the semiconductor memory device includes:
a fifth pin that outputs a signal indicating an operation state of the memory cell array;
a sixth pin usable for restricting a data write to the memory cell array; and
a seventh pin to which a signal indicating an inverted state of data input from the semiconductor memory device is input,
one of the fifth pin, the sixth pin, and the seventh pin is usable as the fourth pin, and
the other two of the fifth pin, the sixth pin, and the seventh pin are usable as the eighth pin and the ninth pin.

26. The controller according to claim 25, wherein
the one of the fifth pin, the sixth pin, and the seventh pin is settable to the fourth pin, and the other two of the fifth pin, the sixth pin, and the seventh pin are settable to the eighth pin and the ninth pin by performing a set feature, setting a ROM parameter, or using an external terminal.

27. The controller according to claim 23, wherein
the controller is configured to be able to cause the semiconductor memory device to further perform:
a first data input method for inputting data from the first pin and the second pin according to the clock signal input to the third pin; and
a second data input method for inputting data from the first pin, the second pin, the eighth pin, and the ninth pin according to the clock signal input to the third pin.
